(19) United States
(12) Patent Application Publication
(10) Pub. No.: US 2014/0034344 A1
(43) Pub. Date: Feb. 6, 2014

(54) AGRICULTURAL IMPLEMENT KIT

(71) Applicant: Joseph D. Bassett, Sycamore, IL (US)

(72) Inventor: Joseph D. Bassett, Sycamore, IL (US)

(73) Assignee: Dawn Equipment Company, Sycamore, IL (US)

(21) Appl. No.: 13/563,187

(22) Filed: Jul. 31, 2012

(51) Int. Cl. A01B 35/20

(52) U.S. Cl. 172/705; 172/748

(57) ABSTRACT

A kit of components for use in assembling different agricultural implements includes (1) multiple linkages each of which includes a pair of parallel arms mounted for vertical pivoting movement at a first end of the linkage, and adapted to be coupled to a tool-support arm at the second end of the linkage, the multiple linkages having different sizes, (2) multiple coupling elements for coupling said linkages to a toolbar to be attached to a tractor, (3) multiple tool-support arms adapted to be connected to the second ends of the linkages, and (4) multiple tools adapted to be mounted on the tool-support arms.

### FIELD OF THE INVENTION

The present invention relates generally to agricultural implements and, more particularly, to an agricultural implement kit that contains components for use in assembling a variety of different agricultural implements, with at least certain of the kit components being used in multiple implements.

### BACKGROUND OF THE INVENTION

It is well known that agricultural field conditions can vary widely, depending upon both geographical location and weather conditions. It is also well known that the preferences and philosophies of individual farmers regarding the optimum implement to be used in different field conditions, also vary widely.

As an agricultural planter row unit travels across fields with variable soil types, soil moisture, residue levels and topography, it is difficult to maintain a constant depth of fertilizer and/or seed due to the changing conditions. This problem is complicated by the fact that the optimum pressure for any given soil condition can be different for different implements carried by the same row unit. For example, hard soil might require increasing the down pressure of the soil-opening implement more than the down pressure of residue-clearing devices and closing implements carried on the same row unit. On the other hand, farming with higher residue levels may require greater increases in the down pressures for the row-clearing devices than for the opening and closing implements. Thus, it would be desirable to provide farmers with a series of components or sub-assemblies that can be assembled in a variety of different combinations to meet the needs created by different field conditions, different weather conditions, different seasons and different crops.

### SUMMARY

The present invention addresses these varying conditions and preferences by providing a kit of components adapted for use by farmers to assemble agricultural implements tailored to their individual needs at any given time, depending upon changing field conditions, changing weather conditions, and personal preferences. The different kit components can be used by individual farmers to easily and quickly assemble their own customized implements, to suit their individual field conditions as well as their own individual preferences. Many of the components can be used in different implements, thereby reducing the cost of each implement.

According to one embodiment, a kit of components for use in assembling different agricultural implements includes (1) multiple linkages each of which includes a pair of parallel arms mounted for vertical pivoting movement at a first end of the linkage, and adapted to be coupled to a tool-support arm at a second end of the linkage, the multiple linkages having different sizes, (2) multiple coupling elements for coupling said linkages to a toolbar to be attached to a tractor or to another linkage, (3) multiple tool-support arms adapted to be connected to the second ends of the linkages, and (4) multiple tools adapted to be mounted on the tool-support arms.

### BRIEF DESCRIPTION OF THE DRAWINGS

The invention may best be understood by reference to the following description taken in conjunction with the accompanying drawings, in which:

FIG. 1 is a perspective view of a row unit having a gauge wheel, an opening device, dispensing devices and closing devices.

FIG. 2 is a side elevation of one side of the row unit of FIG. 1 with the linkage that connects the row unit to the towing frame, and the linkage that carries the closing devices, in level positions.

FIG. 3 is a side elevation of the opposite side of the row unit of FIG. 1 with the linkage that connects the row unit to the towing frame, and the linkage that carries the closing devices, in level positions.

FIG. 4A is an exploded perspective of the row unit of FIG. 1.

FIG. 4B is the same perspective view shown in FIG. 4A, with the closing wheel module exploded away from the main module.

FIG. 4C is a perspective view of the main module shown in FIGS. 4A and 4B, with the upper and lower portions of that module exploded away from each other.

FIG. 4D is an enlarged, exploded perspective view of the portions of the main module associated with the parallel linkage in that module.

FIG. 5 is the same side elevation shown in FIG. 2 but with the linkage that connects the row unit to the towing frame tilted downwardly to move the implements carried by the row unit to a lowered position.

FIG. 6 is the same side elevation shown in FIG. 2 but with the linkage that connects the row unit to the towing frame tilted upwardly to move the implements carried by the row unit to a raised position.

FIG. 7 is an enlarged perspective view of the closing device module in the row unit of FIG. 1 with the linkage that carries the closing devices in a lowered position.

FIG. 8 is a perspective view of the same module shown in FIG. 7 with the linkage that carries the closing devices in a raised position.

FIG. 9 is an exploded perspective view of the module shown in FIGS. 7 and 8.

FIG. 10 is the same side elevation shown in FIG. 2 but with the linkage that carries the closing devices tilted downwardly to move the closing devices to a lowered position.

FIG. 11 is the same side elevation shown in FIG. 2 but with the linkage that carries the closing devices tilted upwardly to move the closing devices to a raised position.

FIGS. 12a, 12b and 12c are enlarged cross-sections taken along line 12-12 in FIG. 11 with the linkage that carries the closing devices in three different positions.

FIG. 13 is an enlargement of a central portion of the side elevation shown in FIG. 2, showing the height-adjustment mechanism for the gauge wheel and the opening device.

FIG. 14 is a further enlarged side perspective view of the structure shown in FIG. 13.

FIG. 15 is an enlarged front perspective view of the gauge wheel and the opening disc in the row unit of FIGS. 1-14.

FIG. 16 is an enlarged rear perspective view of the closing wheel assembly in the row unit of FIGS. 1-14.

FIG. 17 is a further enlarged and exploded rear perspective view of the rear closing wheel and its mounting mechanism.

FIG. 18 is an enlarged section taken along line 18-18 in FIG. 16.

FIG. 19A is a rear perspective view, a top plan view, a rear elevation view and a side elevation view of the rear closing wheel and its mounting mechanism, with the adjustment mechanism set in a position that is offset in a clockwise direction from the 12 o'clock position.

FIG. 19B is a rear perspective view, a top plan view, a rear elevation view and a side elevation view of the rear closing wheel and its mounting mechanism, with the adjustment mechanism set in the 12 o'clock position

FIG. 19C is a rear perspective view, a top plan view, a rear elevation view and a side elevation view of the rear closing wheel and its mounting mechanism, with the adjustment mechanism set in a position that is offset in a counter-clockwise direction from the 12 o'clock position

FIG. 20 is a partially exploded front perspective view of one side of a modified row unit similar to the row unit shown in FIG. 1 with the addition of a module that includes a pair of residue-clearing wheels at the front end of the unit.

FIG. 21 is an enlarged and exploded perspective view of the residue-clearing-wheel module in the row unit shown in FIGS. 19 and 20.

FIG. 22 is a partially exploded front perspective view of the row unit shown in FIG. 20 but with two different modified modules that can be used with residue clearing wheels or other devices.

FIG. 23 is an enlarged perspective of a side dressing fertilizer coulter row unit.

FIGS. 24A and 24B are further enlarged perspectives of first and second attachment member in the row unit shown in FIG. 23.

FIGS. 25A and 25B are side perspectives of the same attachment members shown in FIGS. 24A and 24B.

FIG. 26 is an exploded perspective of the attachment members shown in FIGS. 24A-2%B, along with the parallel linkage coupled to the second attachment member.

FIG. 29 is a top plan view of an elongated connector for mounting tool-support elements directly behind the toolbar drawn by a tractor.

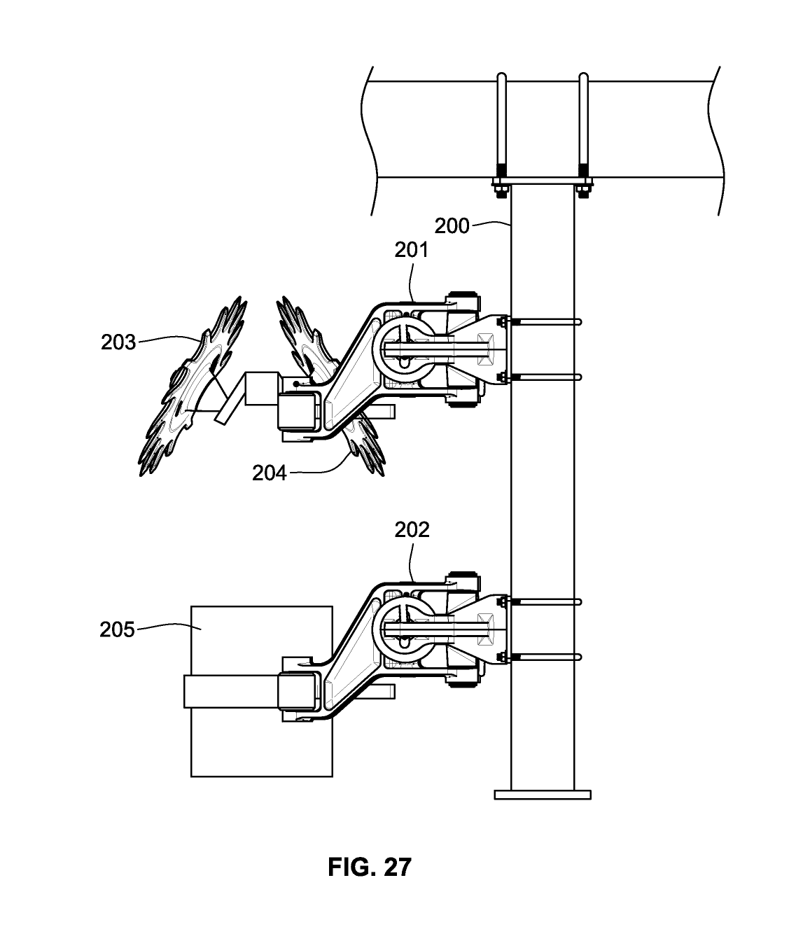

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

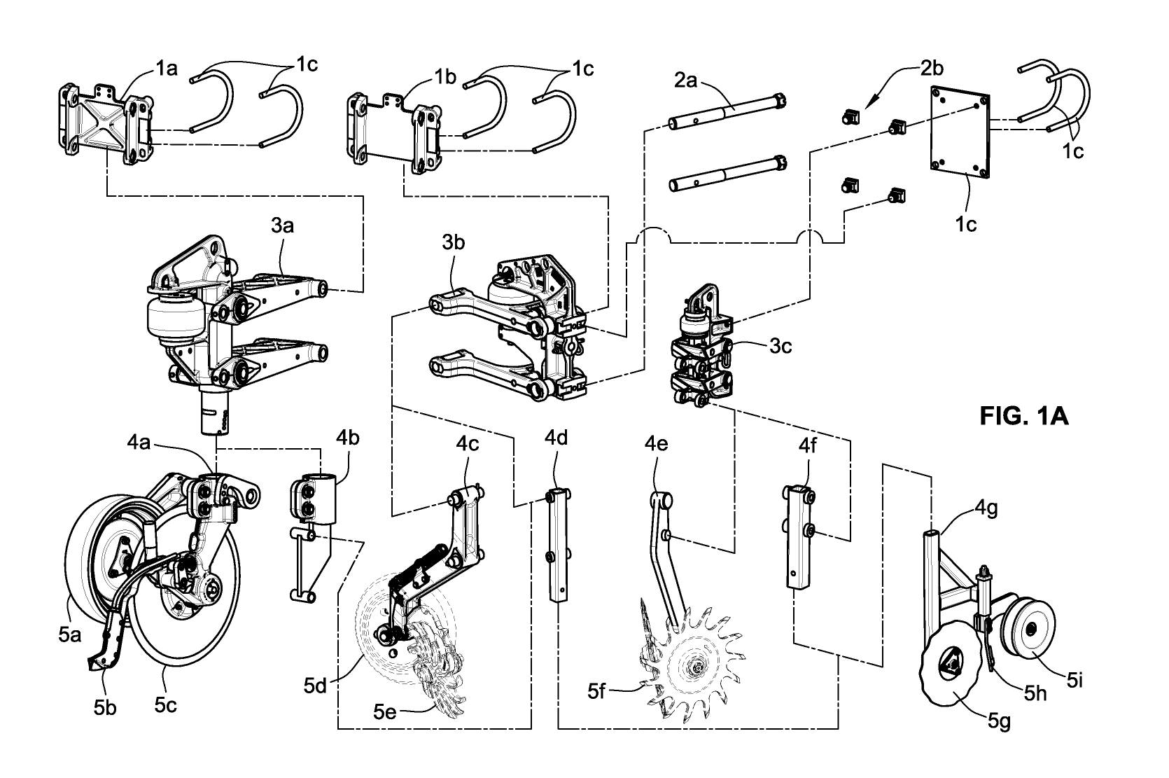

Turning now to the drawings and referring first to FIG. 1A, an illustrative kit of components for assembling a variety of different agricultural implements includes multiple coupling components 1 and 2, multiple linkages 3, multiple tool support elements 4, and multiple tools 5. The coupling components 1a-1c are for coupling the linkages 3a and 3b to a toolbar drawn by a tractor, and the coupling components 2a and 2b are for coupling the linkages 3b and 3c to each other. The coupling component 1c and 2b are for coupling the linkage 3c to a toolbar.

Each of the linkages 3a-3c provides vertical pivoting movement of the trailing end of the linkage relative to the leading end of the linkage, while also permitting the down pressure on the trailing end of the linkage to be remotely controlled. The tool support elements 4a-4g serve to couple one or more selected tools 5 to the trailing ends of one of the linkages so that the controllable down pressure applied to the trailing end of the linkage is also applied to any tools coupled to that linkage. The kit components can be assembled in a wide variety of different combinations and configuration to form different implements, with many of the components are capable of being used as parts of different implements rather than being dedicated to just one implement. It should also be understood that that the particular collection of components in the kit illustrated in FIG. 1 is just one example, and that many other kit components can be added to or substituted for the particular components shown in FIG. 1. Also, many different combinations of the various components can be included in any given kit, depending upon the market segment for which the kit is intended.

The lower end of a vertical stem 3a′ of the linkage 3a is adapted to telescope into a mating socket in the top of a tool support element 4a or 4b. The element 4b in turn is adapted to be coupled to a tool support element 4d adapted to telescope into the lower end of a tool support element 4f. In linkage 3b, the vertically movable ends of the parallel arms form yokes for receiving tool-support elements such as 4c or 4d. The tool support elements can carry either a single tool or multiple tools, as in the case of tool-support elements 4a, 4c, 4e and 4g.

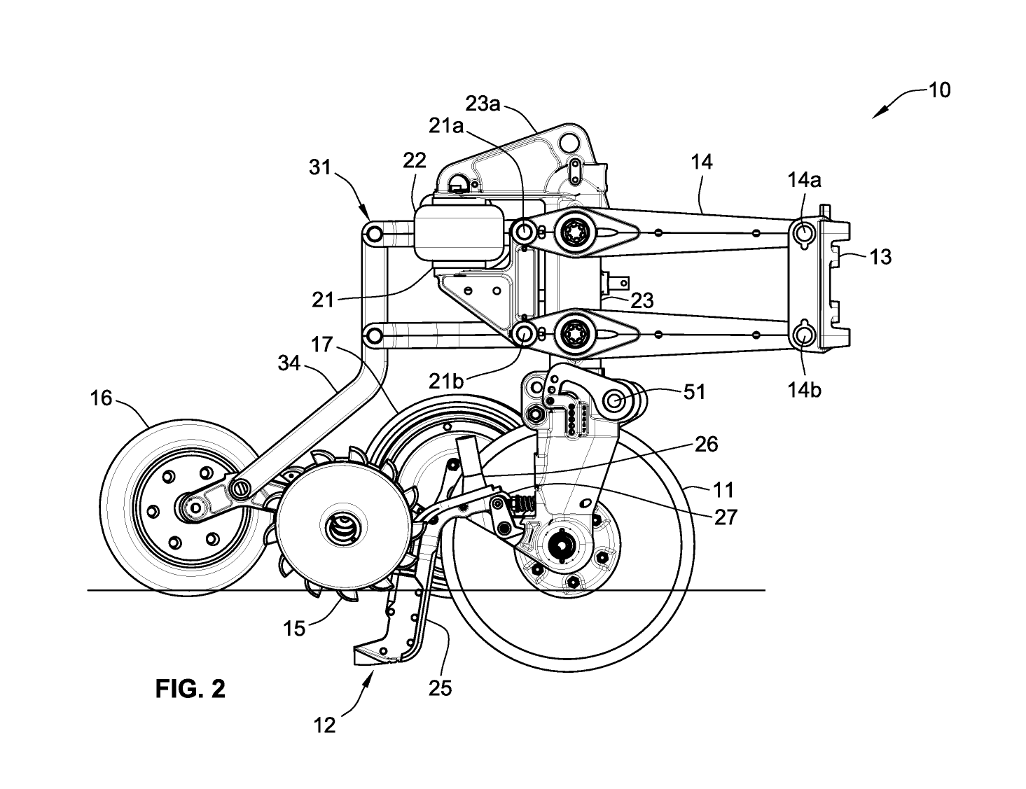

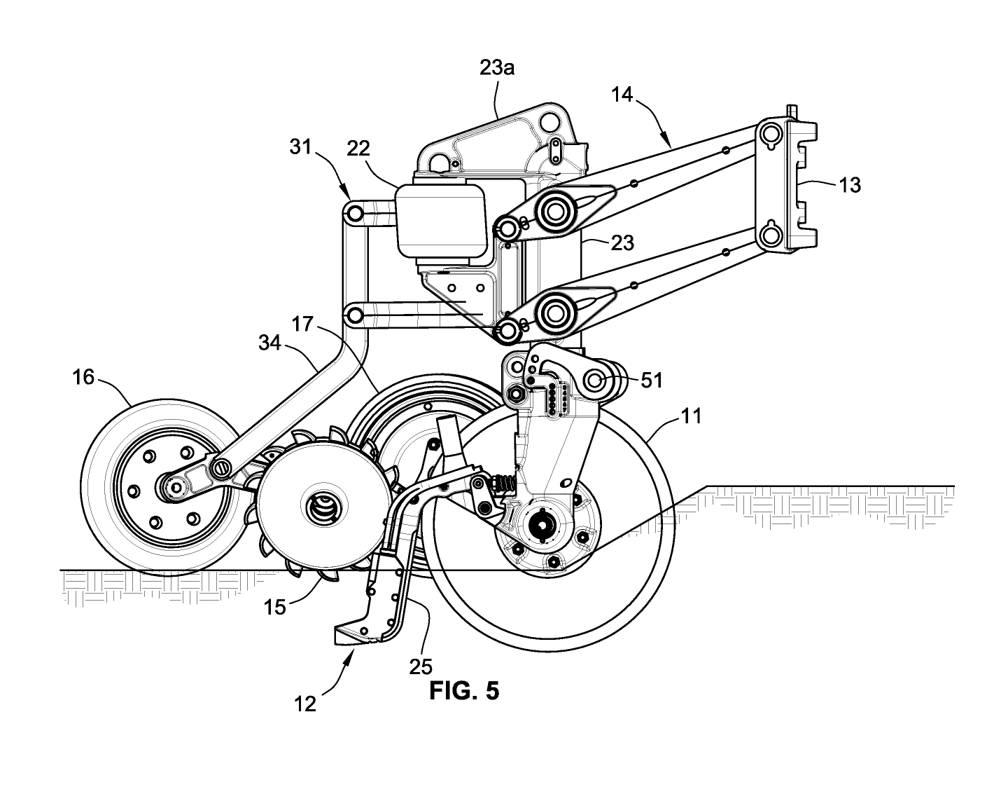

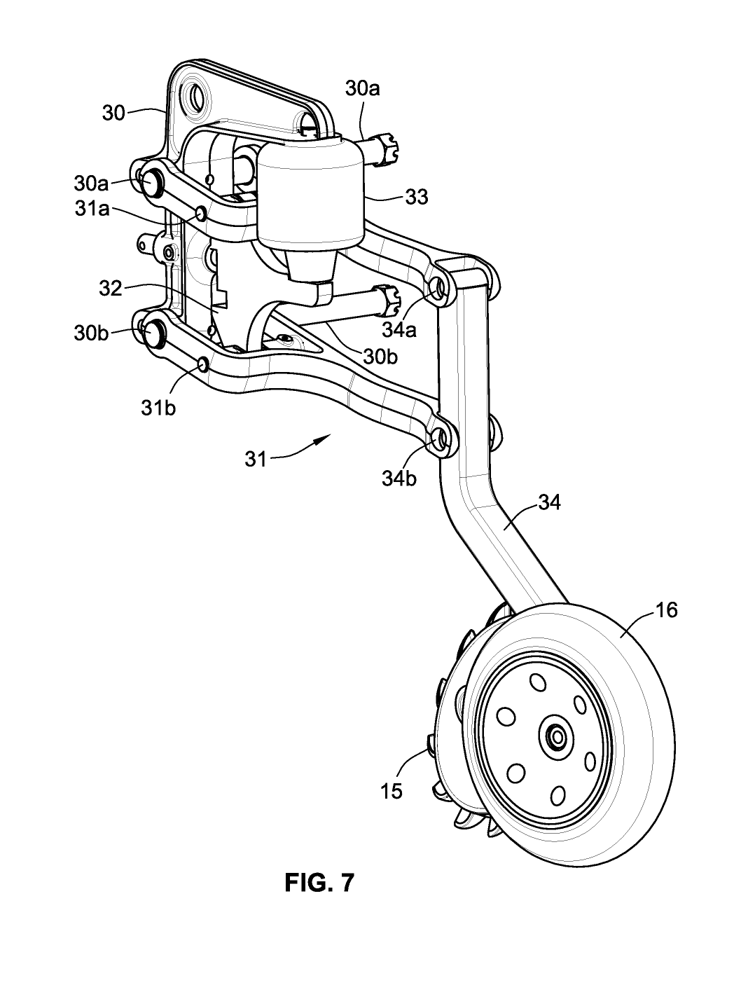

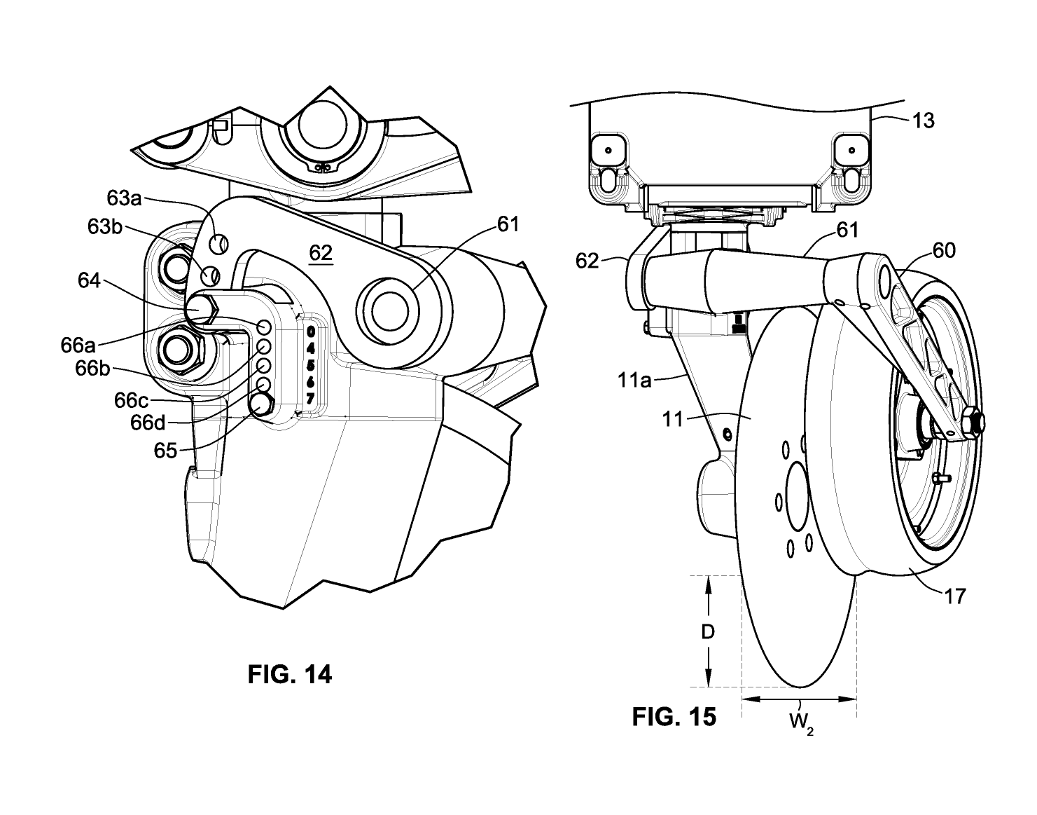

The right-hand end of the linkage 3b can be connected to either the side of the linkage 3a, as in the example described below, or to the front side of the linkage 3c so that the linkages 3b and 3c are connected in tandem. Specifically, the right-hand end of the linkage 3b includes (1) a pair of through holes 200 and 201 for receiving the connecting rods 2a for coupling the linkage 3b to the side of the linkage 3a, and (2) a pair of T slots 202 and 203 that can receive the T-shaped heads of the mounting screws 2b threaded into four mounting holes on the front of the small linkage 3c. In the example of FIGS. 1A-22 described below, the vertically moving end of the linkage 3b is the trailing end, but in other implements the linkage 3b can be rotated 180° horizontally so that the vertically moving end of the linkage 3b is the leading end. The linkage 3b can be used in tandem with the linkage 3a, as the example of FIGS. 1A-22, and/or in tandem with the linkage 3c, or the linkage 3b can be used by itself as the only pivoting linkage in an implement. In other words, each of the linkages 3a-3c is a versatile module that can be used in combination with other versatile modules to produce a wide variety of different implements.

FIGS. 1B-22 illustrate a row unit 10 assembled from components 1a, 1c, 2a, 3a, 3b, 4a and 4d in FIG. 1A. The coupling plate 1a in FIG. 1A corresponds to plate 13 in FIG. 1B, the linkage 3a in FIG. 1A corresponds to the linkage 14 in FIG. 1B, the linkage 3b in FIG. 1A corresponds to the linkage 31 in FIG. 1B, the linkage 3a in FIG. 1A corresponds to the linkage 14 in FIG. 1B, the tools 4a in FIG. 1A correspond to the tools 11, 12 and 17 in FIG. 1B, and the tool support 4d in FIG. 1A corresponds to the tool support 34 in FIG. 1B. The C-clamps 1c in FIG. 1A are used to couple the plate 13 to a conventional square-tube toolbar, and the coupling rods 2a in FIG. 1A correspond to the rods 14a and 14b in FIG. 1B that are used to couple the linkages 14 and 31 to each other.

The row unit 10 includes a tilted coulter wheel 11 for forming a furrow, and at least one dispensing device 12 for depositing fertilizer and/or seed into the soil. The front end of the row unit 10 includes a front attachment plate 13 connected to a conventional towing frame by a pair of C-clamps 13a and 13b. The rear side of the attachment plate 13 is pivotably connected to the front end of a large linkage module that includes a parallel linkage 14 that is pivotably coupled to the plate 13 by a pair of rods 14a and 14b that pass through the linkage 14 and are attached at both ends to the plate 13.

As the row unit 10 is advanced by the tractor, the opener 11 penetrates the soil to form a furrow or seed slot. The dispensing device 12 deposits fertilizer into the furrow, and then the furrow is closed by a pair of closing wheels 15 and 16 that distribute loosened soil back into the furrow. A gauge wheel 17 determines the depth of the furrow and the height of introduction of fertilizer, etc. Containers (not shown) on the row unit carry the fertilizer, seed and/or chemicals to be dispensed into the furrow.

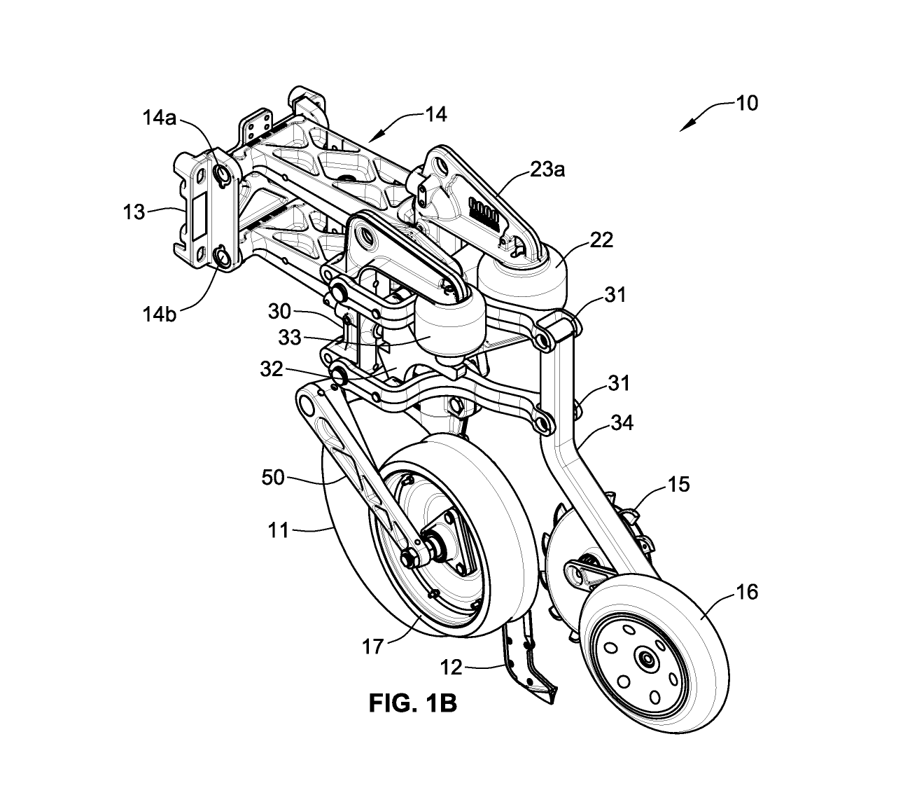

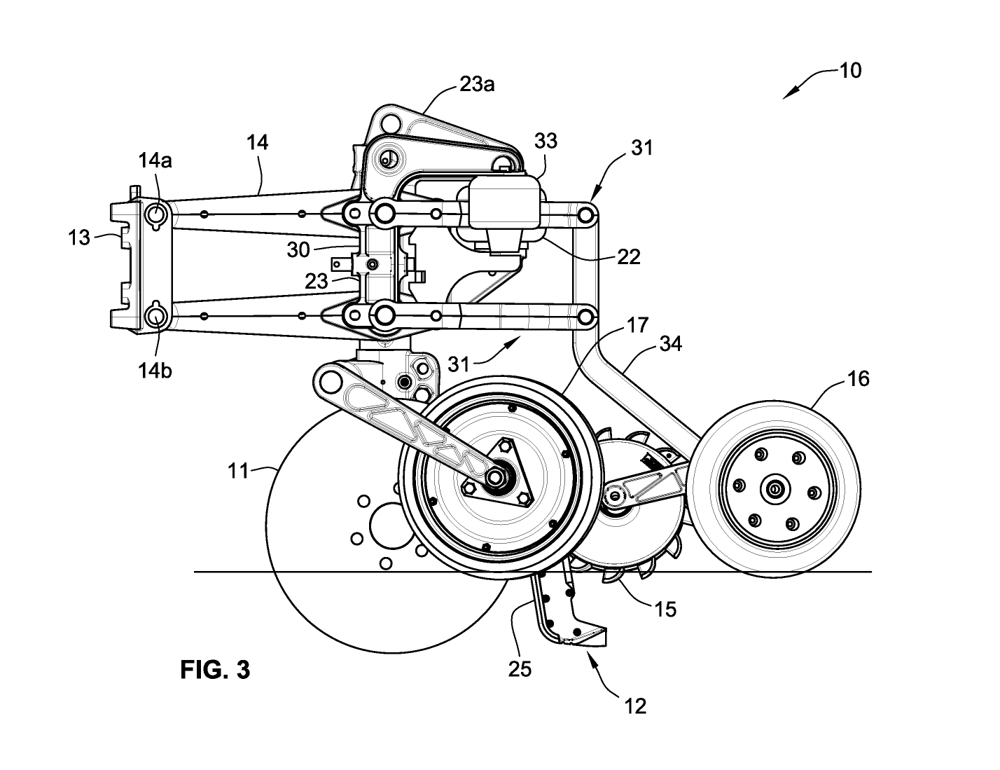

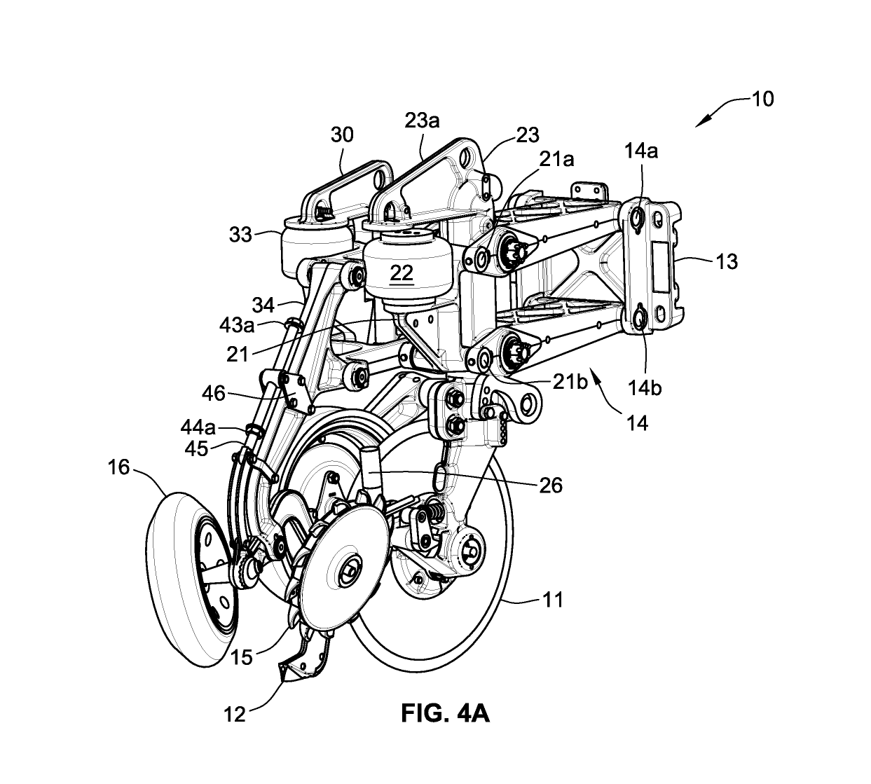

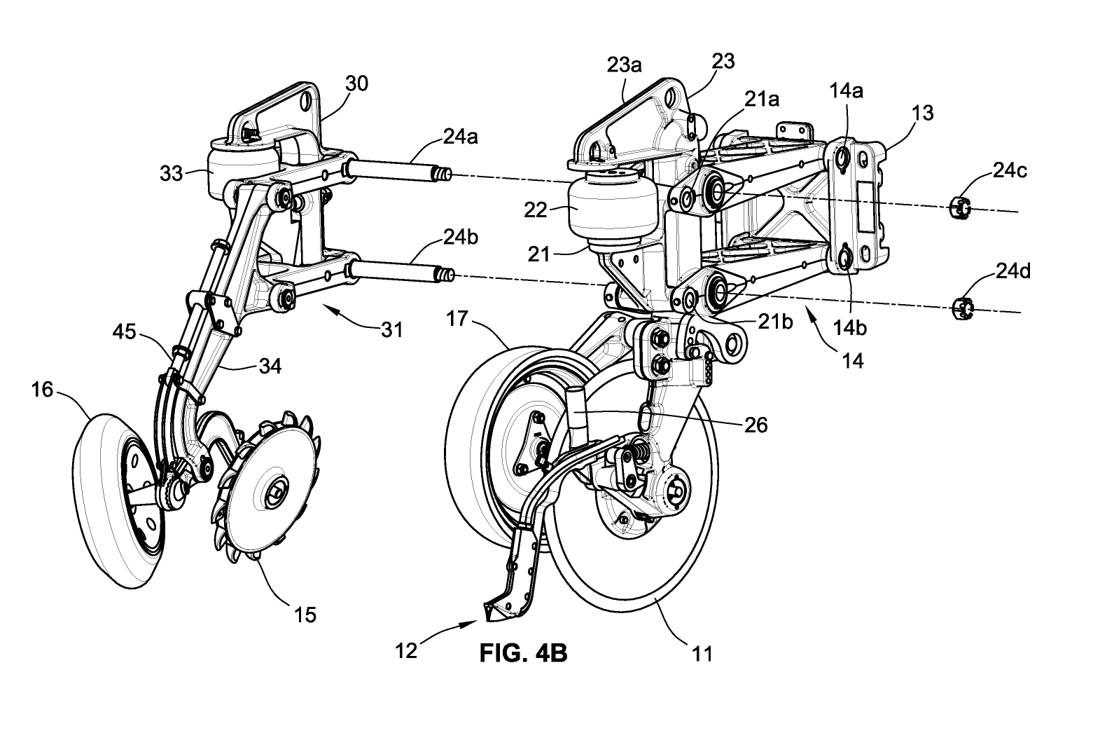

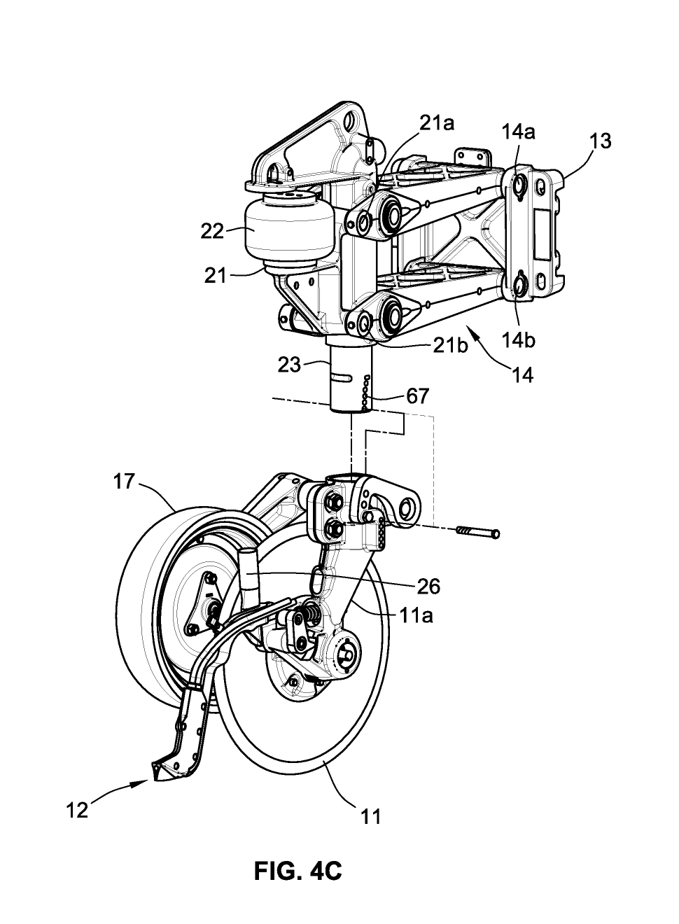

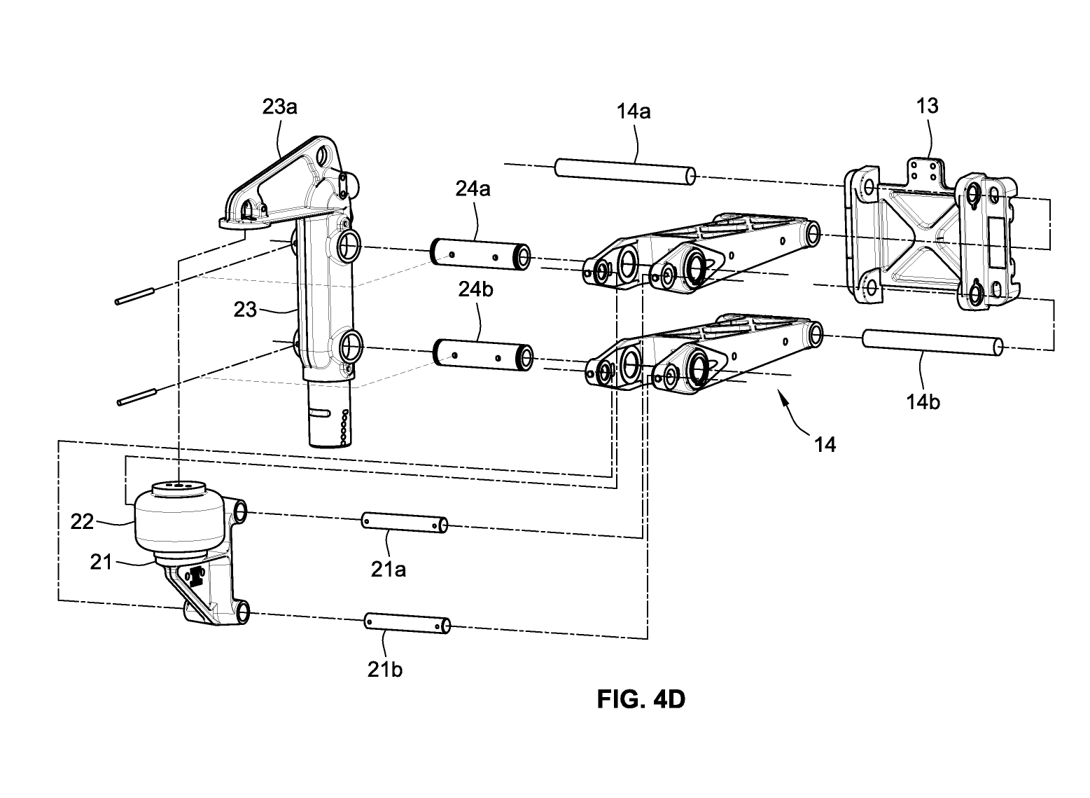

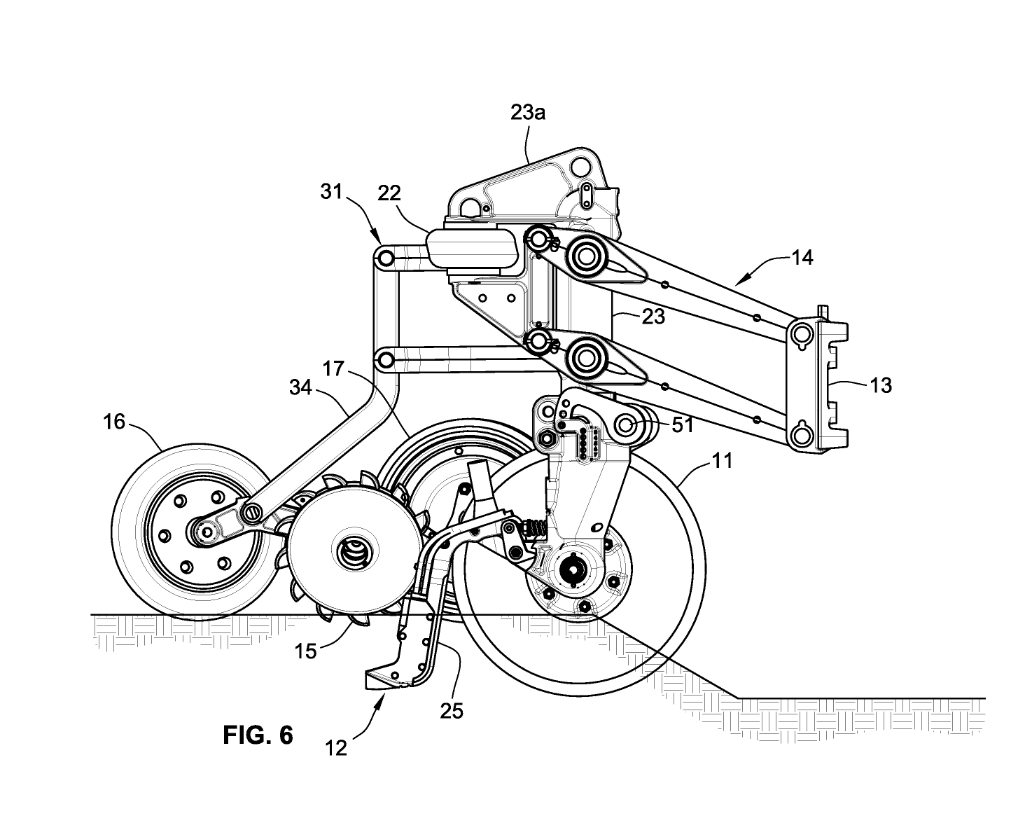

The trailing end of the parallel linkage 14 is pivotably connected to a cradle 21, for a first air spring 22, by a pair of pins 21a and 21b (see FIG. 2). The upper end of the air spring 22 is attached to an arm 23a that is an integral part of a stem 23 that carries the opener 11, the dispensing device 12 and the gauge wheel 17. The stem 23 is attached to a pair of tubes 24a and 24b that are coupled at both ends to the parallel linkage 14 forwardly of the pins 21a, 21b (see FIG. 4D). When the air spring 22 is expanded by increasing the air pressure supplied to the spring, the downward pressure on the trailing end of the parallel linkage 14 is increased, which can (1) pivot that end of the linkage 14 downwardly around the axes of the pivotable connection between the linkage 14 and the front attachment frame 13 (see FIG. 5) and/or (2) increase the downward pressure on the stem 23 and, therefore, on the opener 11. Conversely, when the air spring 22 is contracted by reducing the air pressure supplied to the spring, the downward pressure on the stem 23 and the opener 11 is reduced, which can (1) pivot the trailing end of the linkage 14 upwardly around the axes of the pivotable connection between the linkage 14 and the front attachment frame 13 (see FIG. 7) and/or (2) decrease the downward pressure on the stem 23 and, therefore, on the opener 11. Thus, the downward pressure on the opener 11 may be remotely adjusted for different soil conditions by adjusting the air pressure supplied to the air spring 22.

Referring to FIG. 2, the dispensing device 12 includes both a fluid-delivery device 25 and a dry fertilizer delivery tube 26, both of which are mounted on a connector 27 attached to the stem 23. The upper end of the tube 26 is adapted for connection to a flexible tube that receives dry fertilizer from a conventional hopper (not shown) and conducts that fertilizer to the delivery tube 26. The lower end of the tube 26 is positioned far enough above the soil to clear common obstructions such as rocks, but close enough to the soil to direct the exiting dry fertilizer into the furrow formed by the opener 11.

The tube 26 is located in front of the fluid-delivery device 25 so that the dry fertilizer is delivered to the furrow while the furrow is wide open, i.e., well in front of the closing wheels 15 and 16 that close the furrow around the fluid-delivery device 25. The outer periphery of the front closing wheel 15 is spaced rearwardly from the outer periphery of the opening disc 11, which reduces the entrapment of debris between the opening disc 11 and the closing wheels 15, 16. One embodiment of the fluid delivery device 25 is described in detail in pending U.S. application Ser. No. 12/728,734, filed Mar. 22, 2010, and entitled “Agricultural Implement Having Fluid Delivery Features,” which is incorporated herein by reference. Because the dry-fertilizer delivery tube 26 is mounted on the same connector 27 as the fluid-delivery device 25, the tube 26 follows the movements of the fluid-delivery device 25 as it tracks the furrow.

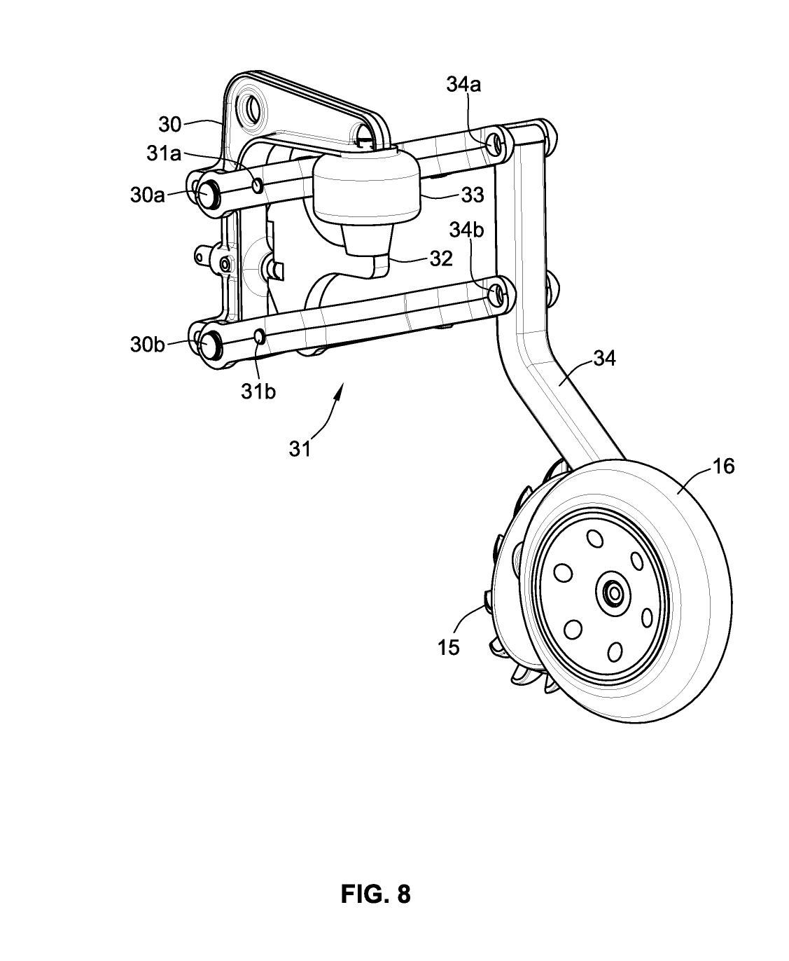

As can be seen in FIGS. 7-12, a closing wheel module includes a second parallel linkage 31 pivotably connected to a stem 30, a second cradle 32 carrying a second air spring 33, and a support arm 34 carrying the closing wheels 15 and 16. The stem 30 fits within a pair of forks formed by the leading end of the linkage 31 (see FIG. 9), and the stem 30 is pivotably connected to the linkage 31 by a pair of rods 30a and 30b that extend through the tubes 24a, 24b and the large linkage 14. A pair of nuts are threaded onto the ends of the rods 30a, 30b to hold everything together. The cradle 32 is pivotably coupled to the linkage 31 by a pair of pins 31a and 31b, and the trailing end of the linkage 31 is pivotably coupled to the support bar 34 by a pair of pins 34a and 34b.

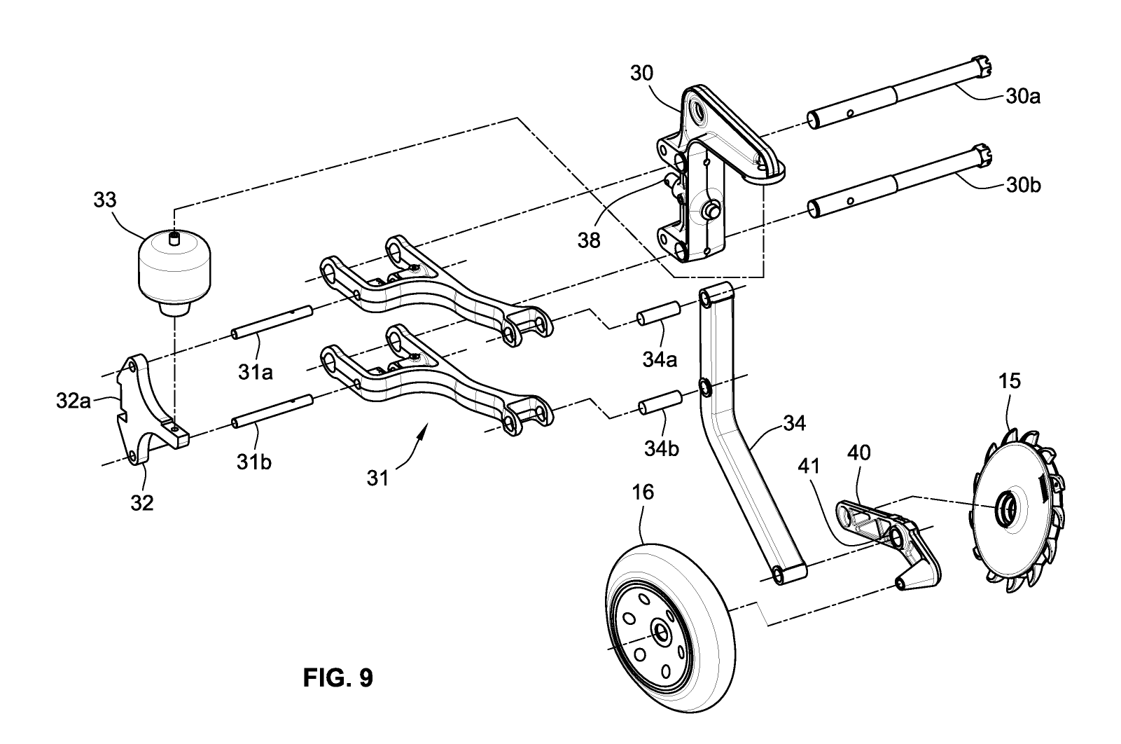

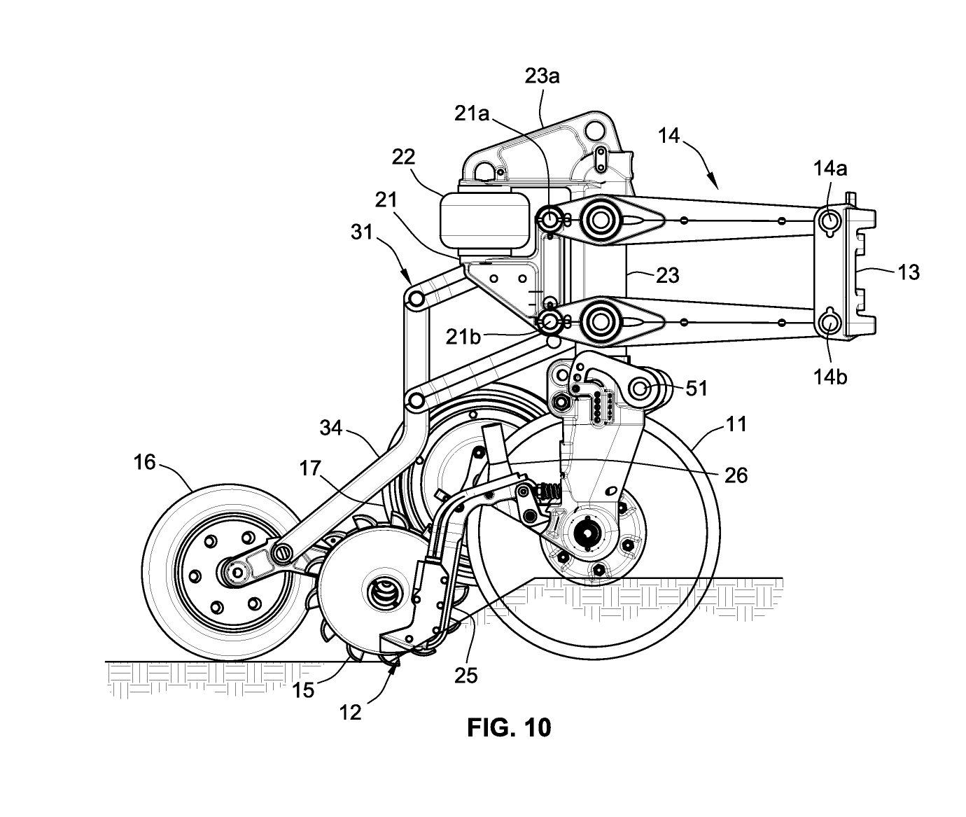

When the air spring 33 is expanded by increasing the air pressure supplied to that spring, the downward pressure on the trailing end of the second parallel linkage 31 is increased, which can (1) pivot that end of the linkage 31 downwardly around the axes of the rods 30a, 30b, as depicted in FIGS. 7 and 10, and/or (2) increase the downward pressure on the support arm 34 and, therefore, on the closing wheels 15 and 16. Conversely, as depicted in FIG. 11, reducing the air pressure supplied to the air spring 33 reduces the downward pressure on the support arm 34 and the closing wheels 15 and 16. Thus, The downward pressure exerted on the closing wheels 15, 16 may be remotely adjusted for different soil conditions by adjusting the air pressure supplied to the air spring 33.

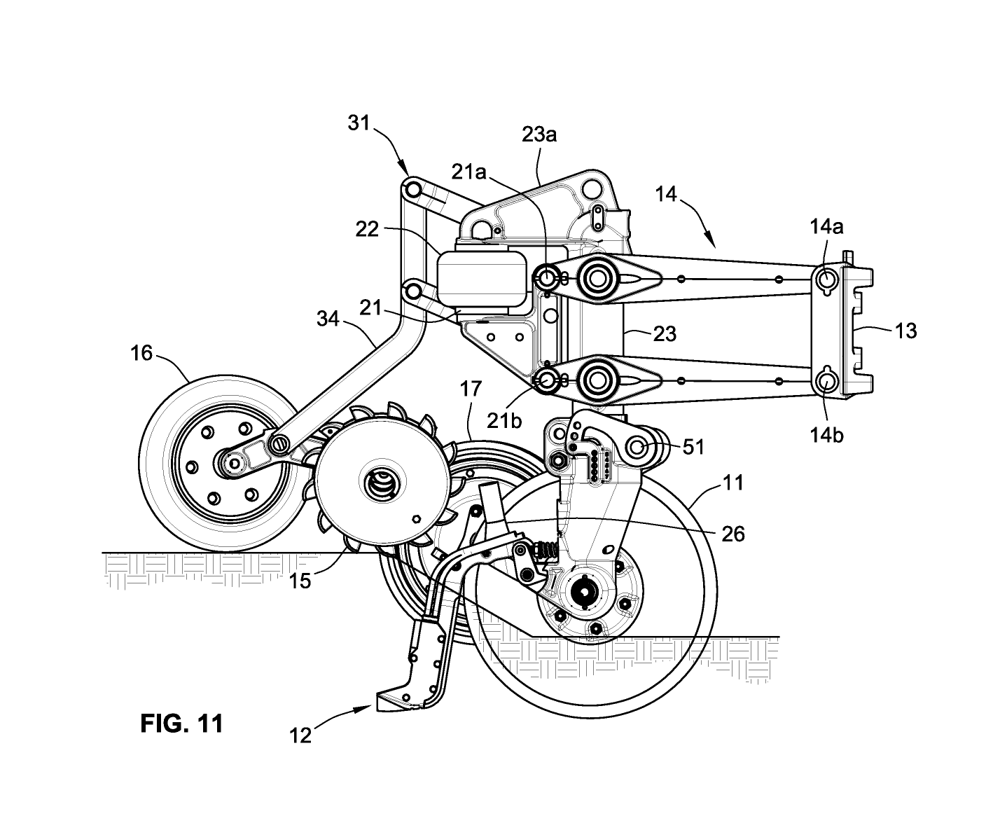

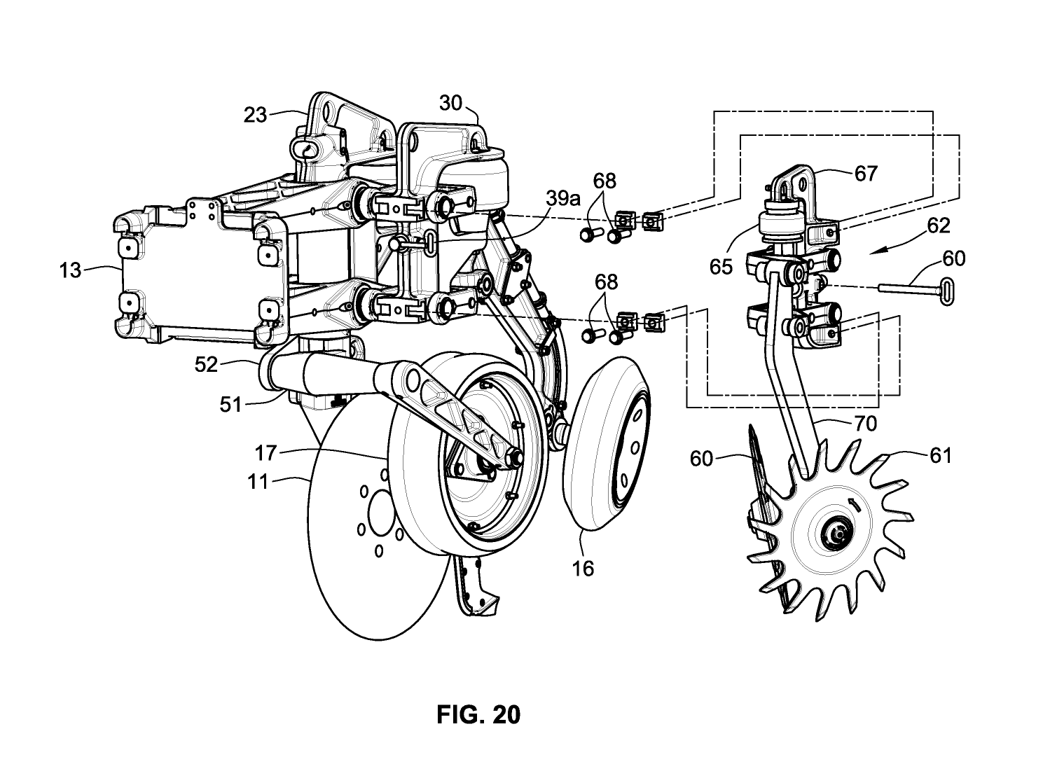

Referring to FIGS. 12A-12C, the cradle 32 includes a vertical plate 32a that is stepped on its leading surface to form two or more undercuts 35 and 36 and a bottom shoulder 37 for engaging a horizontal pin 38 movably mounted in the stem 32. The pin 38 can be locked in different positions by a smaller transverse pin 39 attached to a handle 39a (see FIG. 20) to facilitate manual insertion and withdrawal of the pin 39. The pin 38 has two transverse holes 37a, 37b for receiving the smaller locking pin 39 to lock the pin 38 in different positions, as can be seen in FIGS. 12a-12c. In the position shown in FIGS. 12a-12c, the pin 38 is in a retracted position where it overlaps the undercut 35 and the shoulder 37 so as to limit the range of vertical travel of the cradle 32, as depicted in FIGS. 12a and 12c. When the cradle 32 is raised to the position shown in FIG. 12c, the lower undercut 36 is slightly above the top surface of the pin 38, and thus the pin 38 can be moved to its most advanced position to lock the cradle at that elevation.

It can be seen that the stem 30 is attached to the side of the stem 23 to form an asymmetric arrangement that permits the stem 30 and cradle 32 to be accessed from the side of the row unit. This enables the operator to stand between furrows or crop rows when making adjustments, or when installing or removing different modules, in the field.

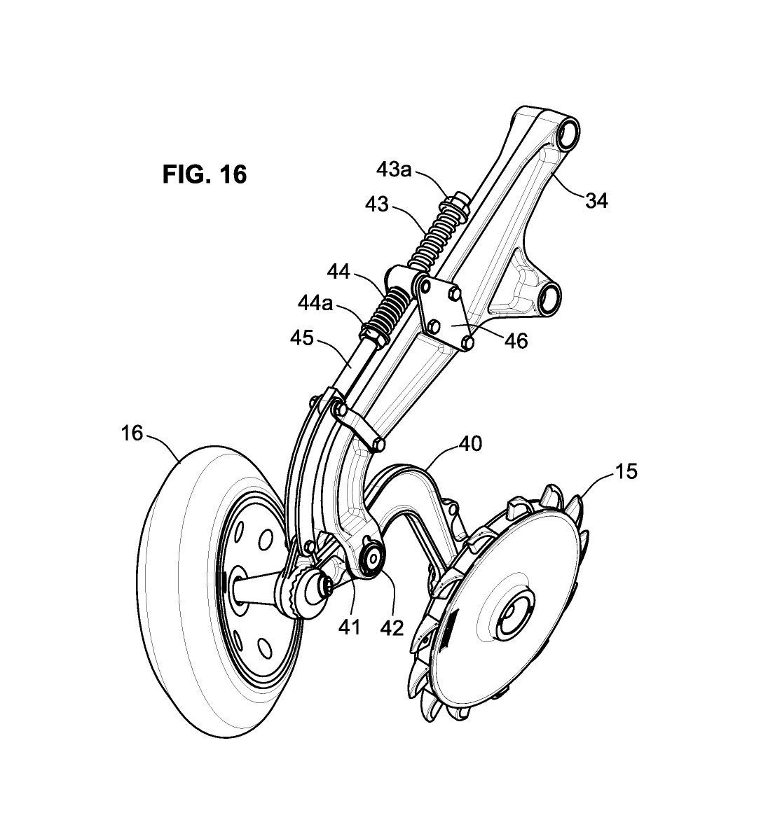

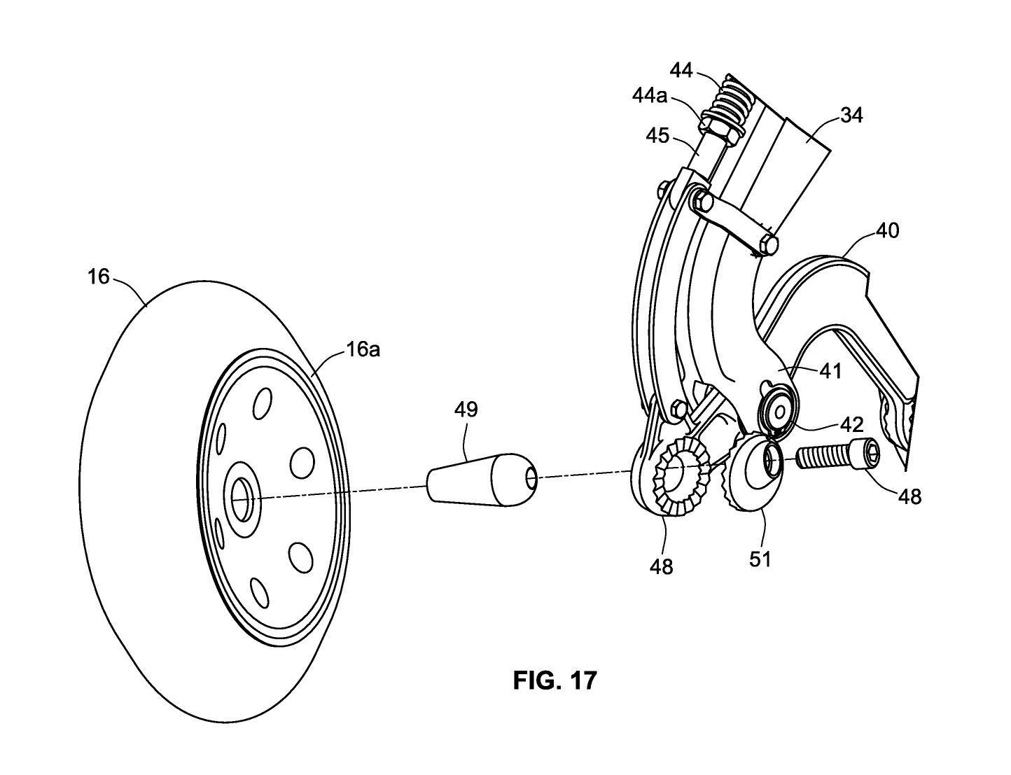

In the embodiment illustrated in FIGS. 16 and 17, the lower end of the support arm 34 is connected to an equalizer arm 40 that carries the two closing wheels 15 and 16. Specifically, the closing wheels 15 and 16 are journaled on opposite ends of the equalizer arm 40, and the lower end of the support arm 34 forms a yoke 41 that is attached to an intermediate portion of the equalizer arm 40 by a bolt 42. The location of the bolt 42 relative to the opposite ends of the equalizer arm determines how the downward pressure transmitted by the support arm 34 is proportioned between the two closing wheels 15 and 16.

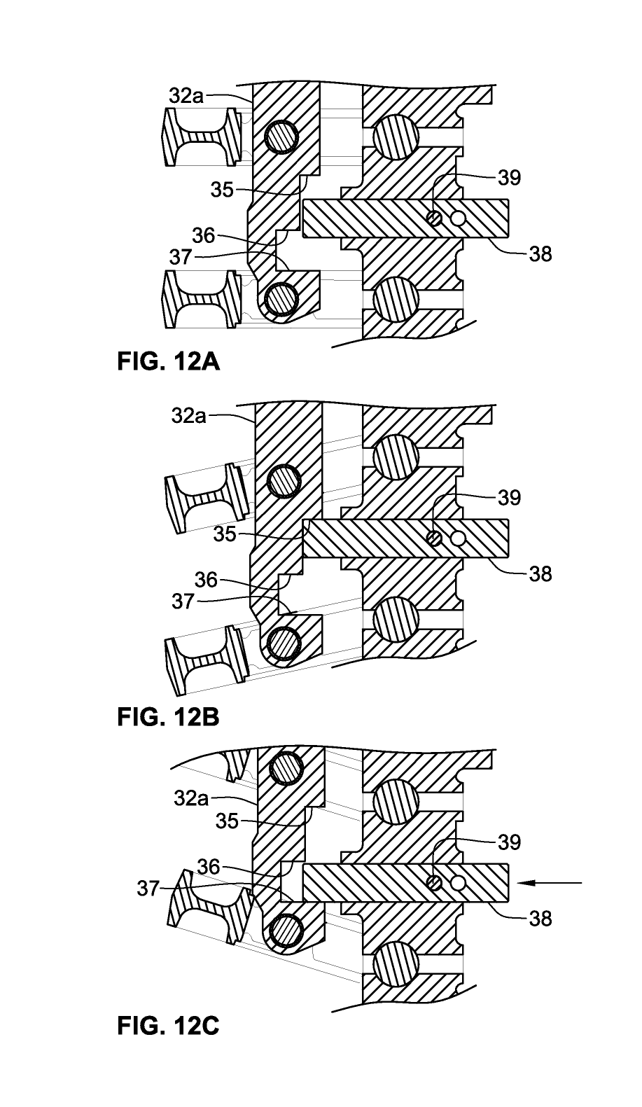

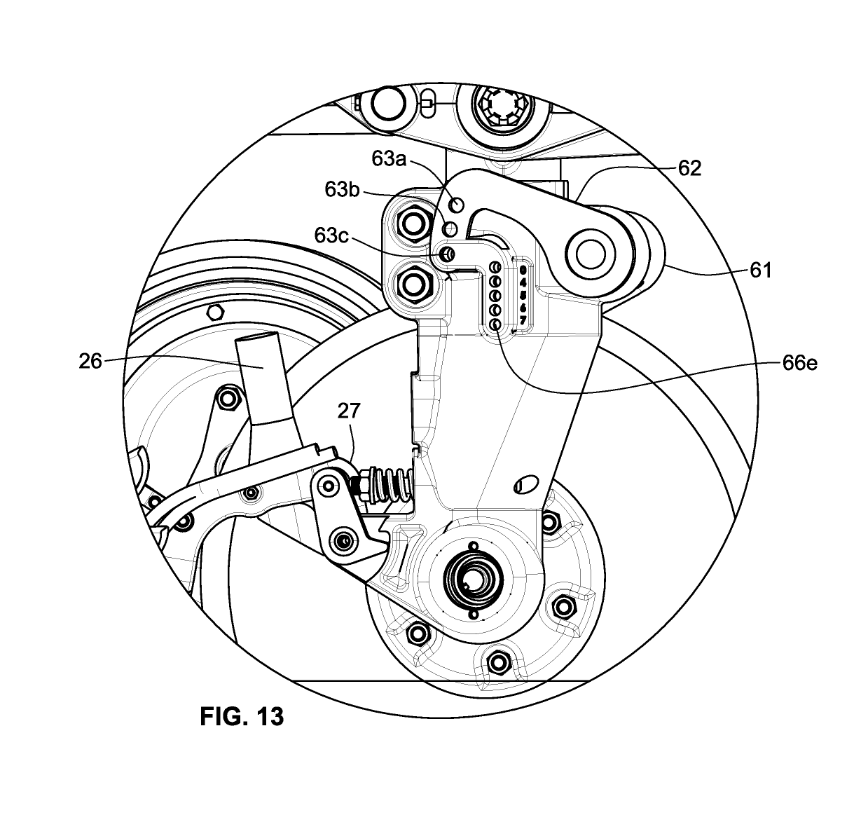

Referring next to FIGS. 13 through 15, the gauge wheel 17 is journaled on the end of a support arm 60 connected to one end of a horizontal shaft 61 that extends through the stem 23. The other end of the shaft 61 is connected to an adjustment arm 62 that can be pivoted to align any of three holes 63a-63c with a mating hole in the stem 23, so that a bolt 64 (see FIG. 14) can be passed through the aligned hole 63a, 63b or 63c and threaded into the mating hole in the stem 23 for the purpose of setting the height of the gauge wheel 17 relative to the opening disc 11. A second bolt 65 is inserted in one of five holes 66a-66e to adjust the angle of the opener 11 relative to the longitudinal axis of the furrow. This bolt 65 fits into a corresponding one of a series of vertically spaced holes 66a-66e formed in the base of the stem 23. As can be seen in FIG. 4C, the holes 66 are located at different circumferential positions in the stem 23, so that the support arm 11a for the opener 11 must be rotated to bring the hole 66 selected for the bolt 65 into register with the hole 66 that is located at the same height as the selected hole 66.

In the embodiment depicted in FIG. 16, a pair of manually adjustable biasing springs 43 and 44 are coupled between the support arm 34 and the trailing end of the equalizer arm 40 by a rod 45 and a linkage 46, to permit further adjustments of the down pressure on the closing wheels 15 and 16. The two springs 43 and 44 can be separately adjusted by turning respective nuts 43a and 44a to increase or decrease the compression of the respective springs. Increasing the compression of the upper spring 43 increases the force pulling the rod 45, and thus the trailing end of the equalizer arm 40, upwardly; this has the effect of reducing the down pressure on the rear closing wheel 16 and increasing the down pressure on the front closing wheel 15. Increasing the compression of the lower spring 44 has the opposite effect, increasing the force pushing the rod 45, and thus the trailing end of the equalizer arm 40, downwardly; this has the effect of increasing the down pressure on the rear closing wheel 16 and decreasing the down pressure on the front closing wheel 15.

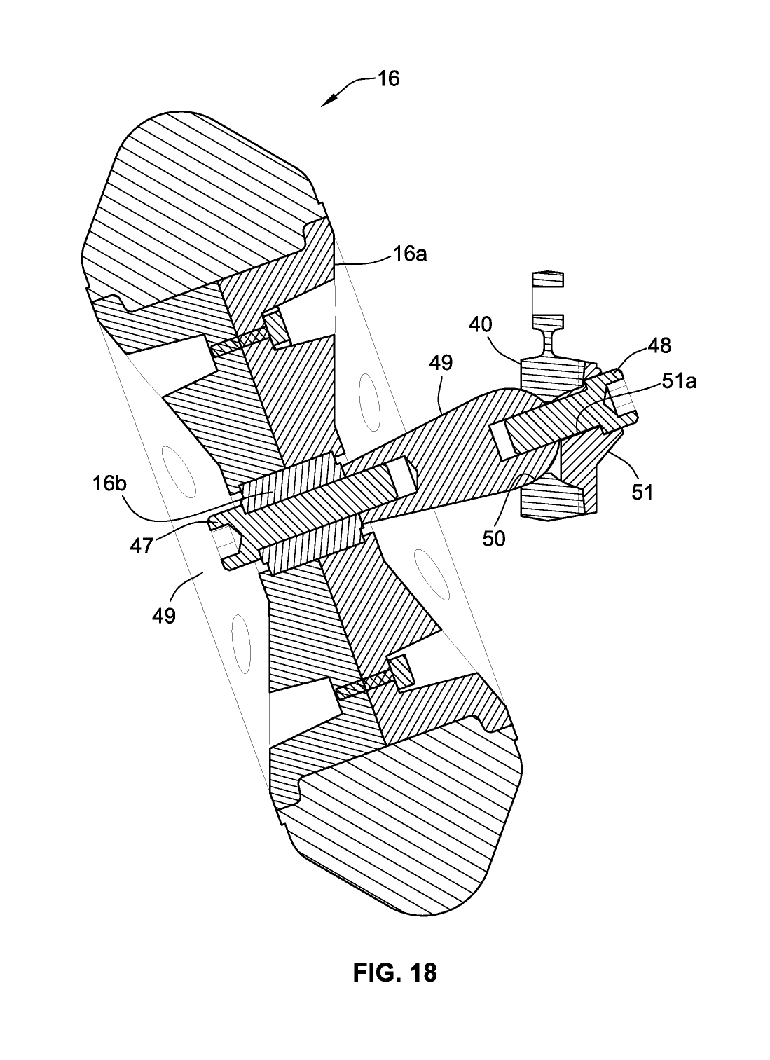

FIGS. 16-20 illustrate an adjustment mechanism provided at the trailing end of the equalizer arm 40 to permit adjustment of the angular position of the rear closing wheel 16. This closing wheel 16 includes a rim 16a and a bearing sleeve 16b attached to the equalizer arm 40 by a pair of bolts 47 and 48 threaded into opposite ends of a tapered connecting rod 49. The larger end of the rod 49 has a hemispherical shape to mate with a hemispherical recess in a socket 50 formed by the trailing end of the arm 40, thereby forming a swivel joint that permits adjustment of the angular position of the rod 49, which in turn adjusts the angular position of the closing wheel 16. As can be seen in FIG. 18, the bolt 48 passes through a hole 51a in a cap 51, and the axis of the hole 51 a is neither orthogonal to the plane of the support arm 34 nor centered in the socket 50. The opposed surfaces of the cap 51 and the arm 40 are serrated (see FIGS. 16 and 17) so that the angular position of the cap 51 remains fixed when the bolt 48 is tightened to draw the cap 51 tightly against the arm 40, i.e., the interlocking teeth of the serrated surfaces prevent relative rotational movement of the cap 51 relative to the arm 40. Thus, the angular position of the closing wheel 16 can be varied over a wide range by simply adjusting the angular position of the cap 51.

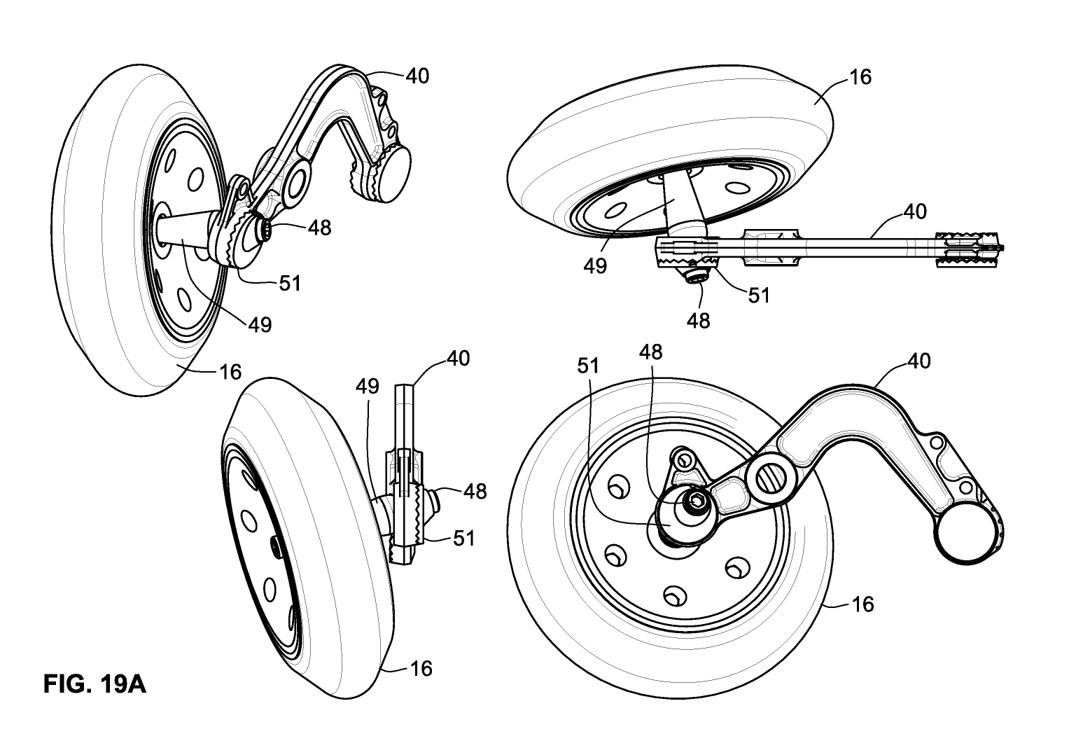

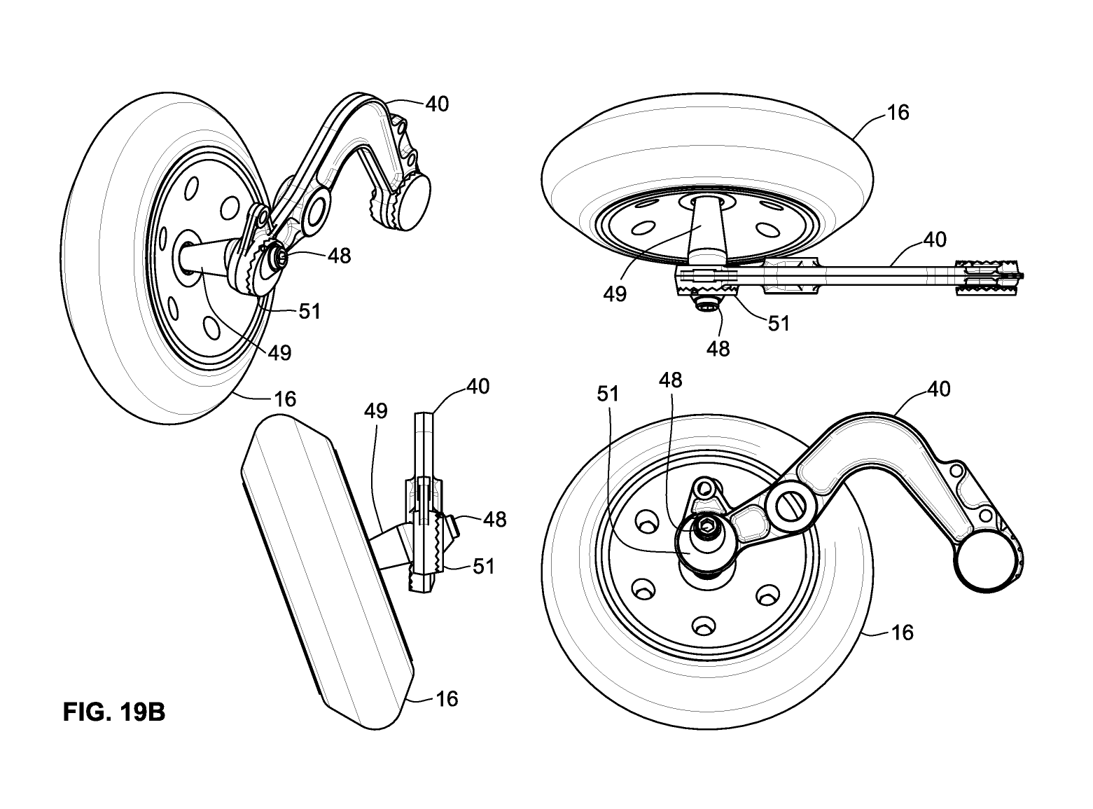

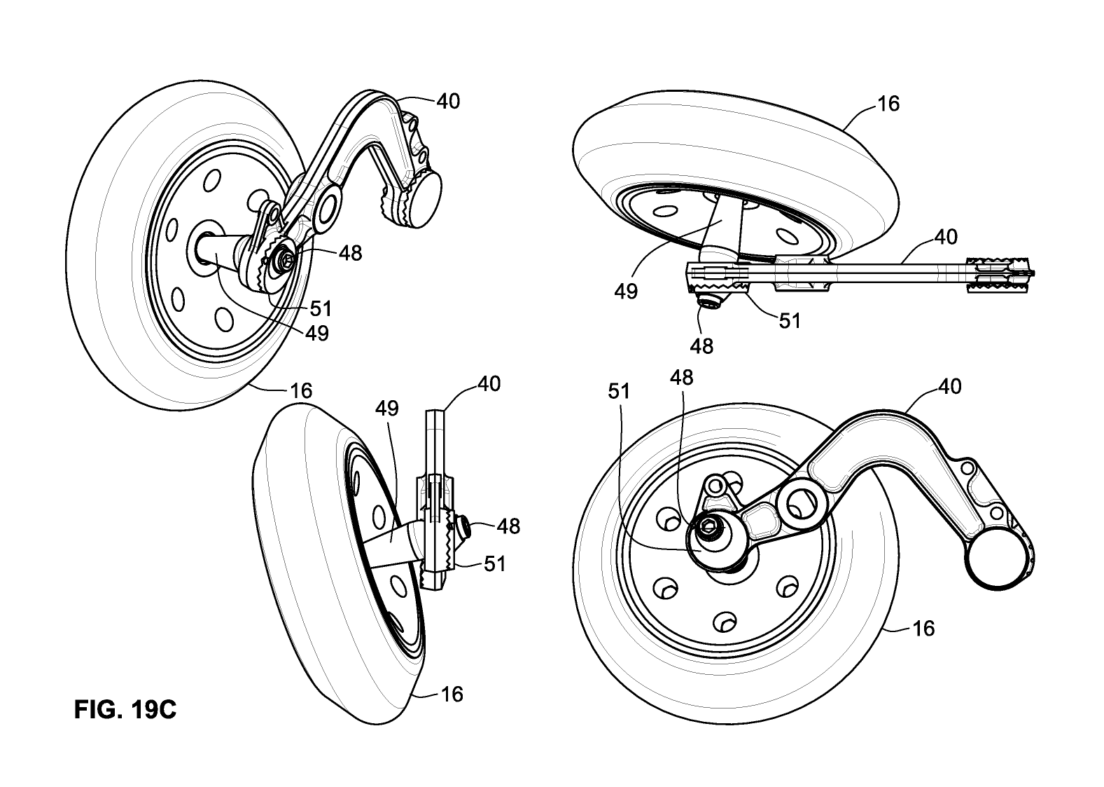

FIGS. 19A-19C illustrate the rear closing wheel 16 in three different angular positions, determined by three different positions of the cap 51 relative to the swivel joint socket 50. Specifically, the cap 51 is set at a 12 o'clock position in FIG. 19b, one notch to the right of the 12 o'clock position in FIG. 19A, and one notch to the left of the 12 o'clock position in FIG. 19A. It can be seen that in FIG. 19B the top of the closing wheel 16 is tilted outwardly, in FIG. 19A both the top and the front of the wheel are tilted outwardly, and in FIG. 19C both the top and the rear of the wheel are tilted outwardly. It will be appreciated that when the cap 51 is set at a 6 o'clock position, the top of the wheel 16 will be tilted inwardly rather than outwardly, and then settings on either side of the 6 o'clock position will tilt the front of the wheel inwardly and outwardly.

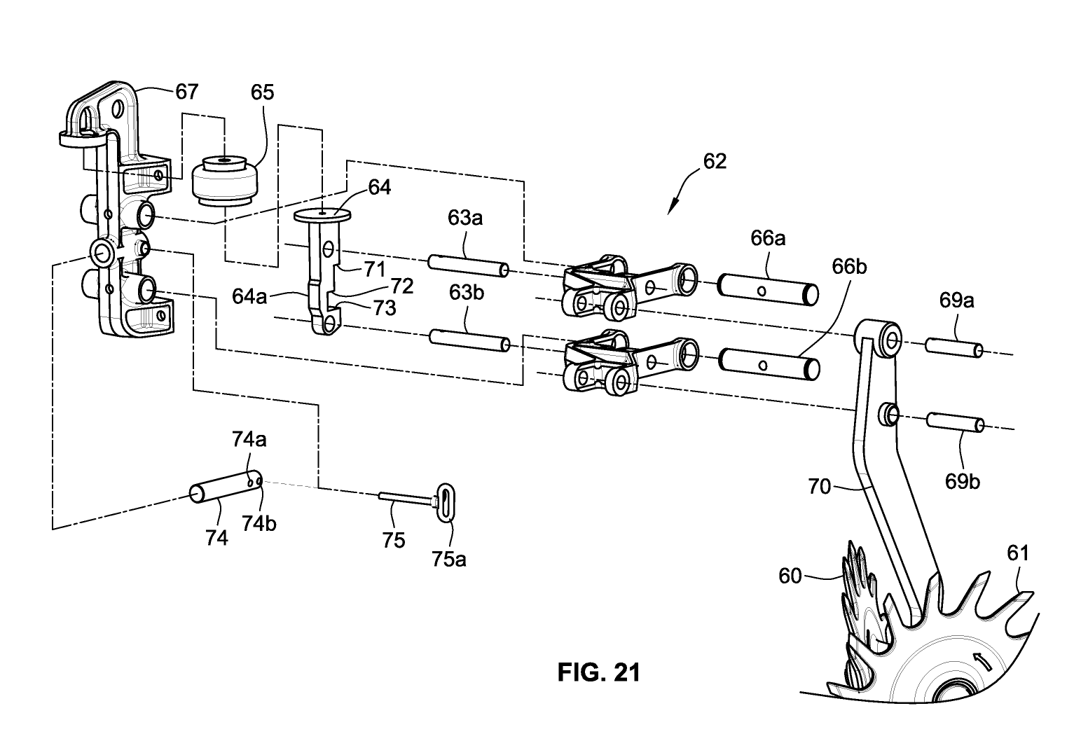

FIGS. 20-21 illustrate a modified embodiment that includes a clearing wheel module comprising a pair of residue-clearing wheels 60 and 61 in front of the opening disc 11, and a third parallel linkage 62 that is pivotably connected by pins 63a, 63b to a third cradle 64 for a third air spring 65. The trailing end of the parallel linkage 62 is pivotably connected by pins 66a, 66b to a stem 67 that is bolted to the stem 30 by bolts 68. The forward end of the linkage 62 is pivotably connected by pins 69a, 69b to a support arm 70 that carries the toothed residue-clearing wheels 60 and 61. The clearing wheels 60, 61 are journaled on the ends of two stub shafts on the lower end of the support arm 70. When the air spring 65 is expanded by increasing the air pressure supplied to that spring, the downward pressure on the leading end of the third parallel linkage 62 is increased, which can (1) pivot that end of the linkage 62 downwardly around the axes of the pivotable connection between the linkage 62 and the pins 69a, 69b and/or (2) increase the downward pressure on the support arm 70 and, therefore, on the clearing wheels 60 and 61. Conversely, when the air spring 65 is contracted by reducing the air pressure supplied to that spring, the downward pressure on the leading end of the third parallel linkage 62 is reduced, which can (1) pivot that end of the linkage 62 upwardly around the axes of the pivotable connection between the linkage 62 and the pins 69a, 69b and/or (2) decrease the downward pressure on the support arm 70 and, therefore, on the clearing wheels 60 and 61. Thus, the downward pressure on the clearing wheels 60, 61 may be remotely adjusted for different soil conditions by adjusting the air pressure supplied to the air spring 65.

The cradle 64 includes a vertical plate 64a that is stepped on its leading surface to form two or more undercuts 71 and 72 and a bottom shoulder 73 for engaging a horizontal pin 74 movably mounted in the stem 67. The pin 74 can be locked in different positions by a smaller transverse pin 75 attached to a handle 75a to facilitate manual insertion and withdrawal of the pin 75. The pin 74 has two transverse holes 74a, 74b for receiving the smaller locking pin 75 to lock the pin 74 in different positions, as depicted in FIGS. 12a-12c for the pin 38. It can be seen that the stem 67 is attached to the front of the stem 30 to maintain the asymmetric arrangement that permits the stem 67 and cradle 64 to be accessed from the side of the row unit.

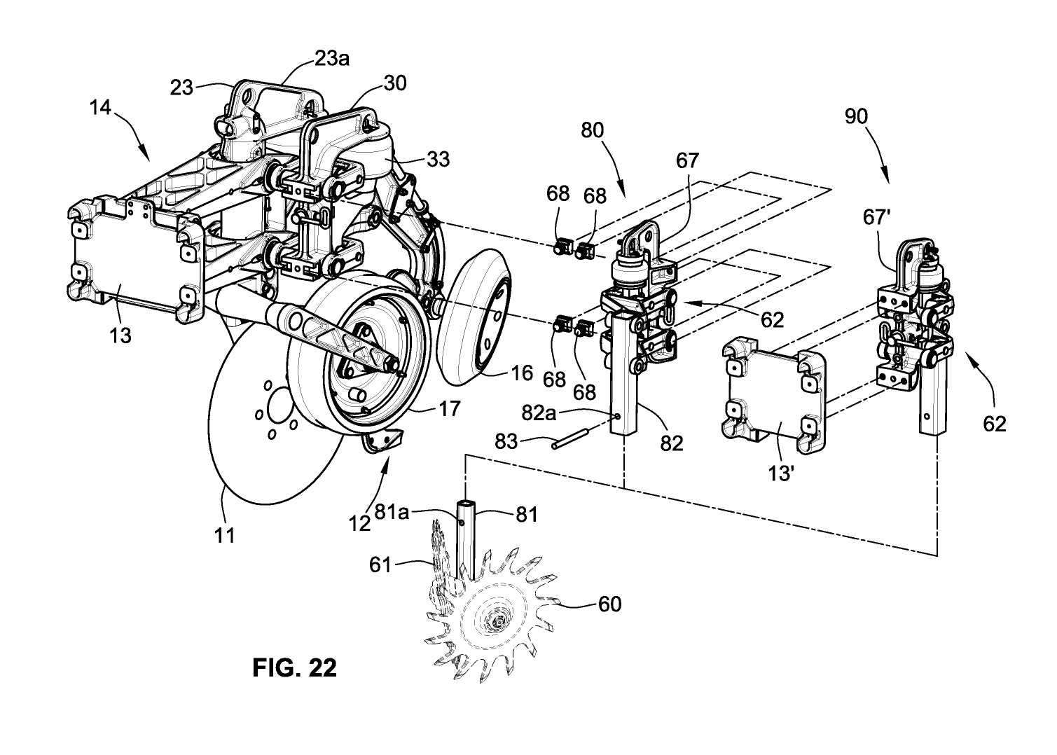

FIG. 22 illustrates two modified clearing-wheel modules 80 and 90. In module 80, the clearing wheels 60 and 61 are carried on the lower end of a square tube 81 that telescopes upwardly into a larger square tube 82 that is pivotably coupled to the linkage 62. The two tubes 81 and 82 are locked together by a pin 83 inserted through mating holes 81a and 82a in the respective tubes 81, 82. Multiple holes may be formed in the tubes 81, 82 to permit adjustment of the vertical position of the clearing wheels 60, 61. The clearing wheels 60, 61 are shown in broken lines, because this embodiment provides a universal stem that can be used to control the down pressure on a variety of different devices. For example, different forms of wheels, discs or blades can be substituted for the clearing wheels 60, 61.

The module 90 in FIG. 22 is similar to the module 80 but rotated 180° around a vertical axis. The stem 67′ is modified to be attached to a frame plate 13′ adapted for connection to a conventional towing frame that is typically hitched to a tractor by a draw bar. This permits the module 90 to be used by itself, if desired.

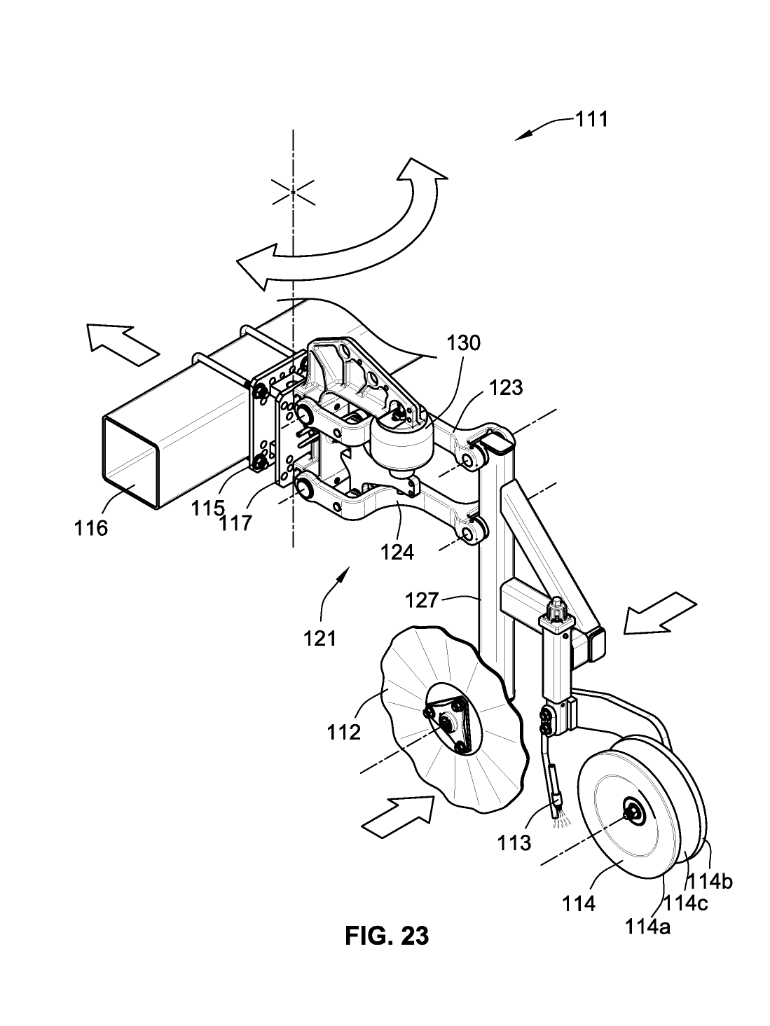

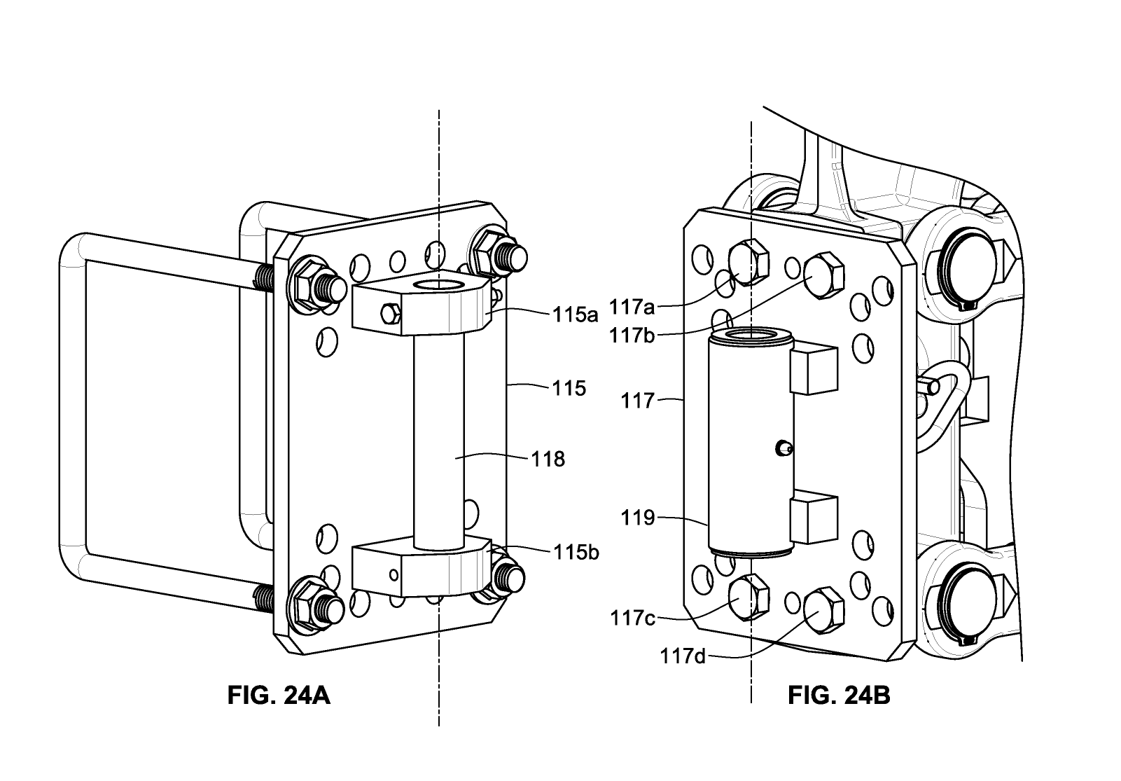

FIGS. 23-26 illustrate a side dressing fertilizer coulter row unit 111 for use in fertilizing a field planted with a crop that is at a seedling stage, when fertilizer is typically applied as a “side dressing,” i.e., slightly offset laterally from each row of seedlings. This is an example of an implement that utilizes a parallel linkage 121 which is the same linkage 31 used in the implement of FIGS. 1B-22, illustrating the interchangeability of that linkage for forming different implements. The tool support 127 in FIG. 23 corresponds to the tool support 4g in FIG. 1A, and the tools 112, 113 and 114 in FIG. 23 correspond to the tools 5g, 5h and 5i in FIG. 1A. The coupling plates 115 and 117 in FIGS. 24A and 24B provide a connection that permits pivoting movement of the row unit about a vertical axis, as described in more detail below. The C-clamps 1c in FIG. 1A are used to couple the plate 115 to a conventional square-tube toolbar, and shorter versions of the coupling rods 2a in FIG. 1A correspond to the rods 125a and 125b in that are used to couple the linkage 121 to the plate 117 in FIGS. 24B-26.

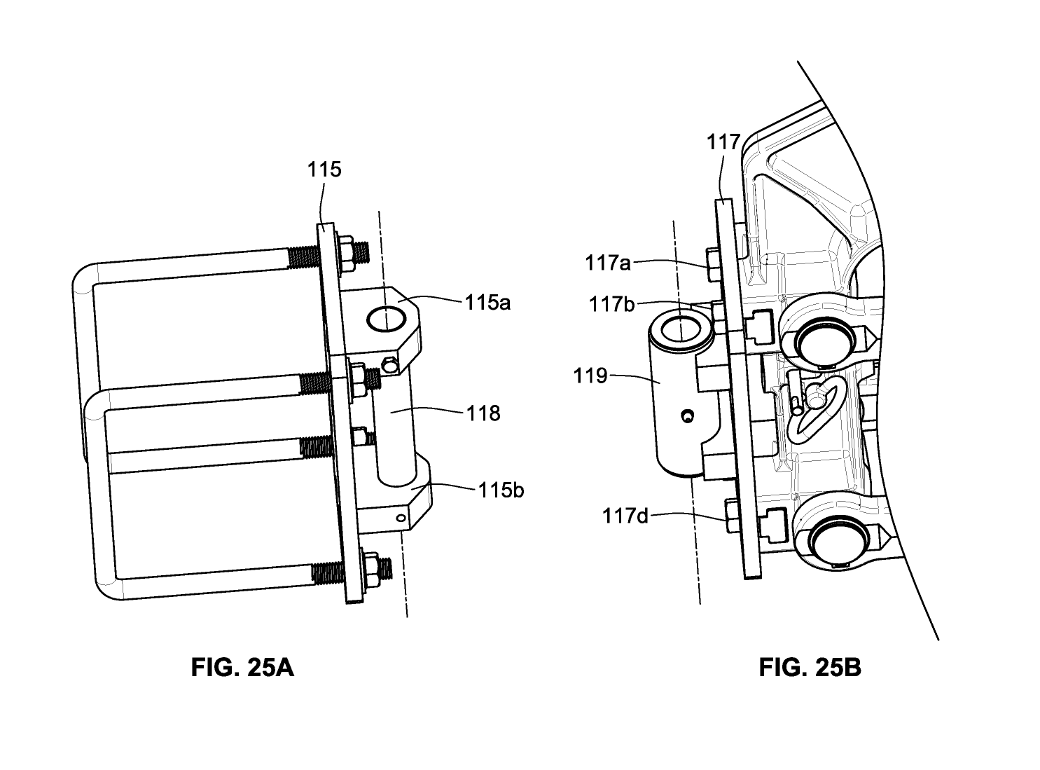

In the fertilizer coulter row unit 111, the vertically movable end of the linkage 121 carries a coulter wheel 112 for forming a slit 121a in the soil, at least one dispensing device 113 for depositing liquid fertilizer into the slit, and a closing wheel 114 for closing the slit to capture and retain the fertilizer in the soil. As can be seen in FIGS. 24A-25B, the front end of the row unit 111 includes a first attachment plate 115 adapted for connection to a conventional towing frame 116 with the same C-clamps used in the implement of FIGS. 1B-22. The rear side of the attachment plate 115 is pivotably coupled to the front side of a second attachment plate 117 by a vertical shaft 118 that passes through a pair of bosses 115a and 115b on the first plate and a cylinder 119 on the second attachment plate 117. The shaft 118 is locked in place by a bolt 118a that passes through the upper boss 115a and the portion of the shaft 118 within that boss.

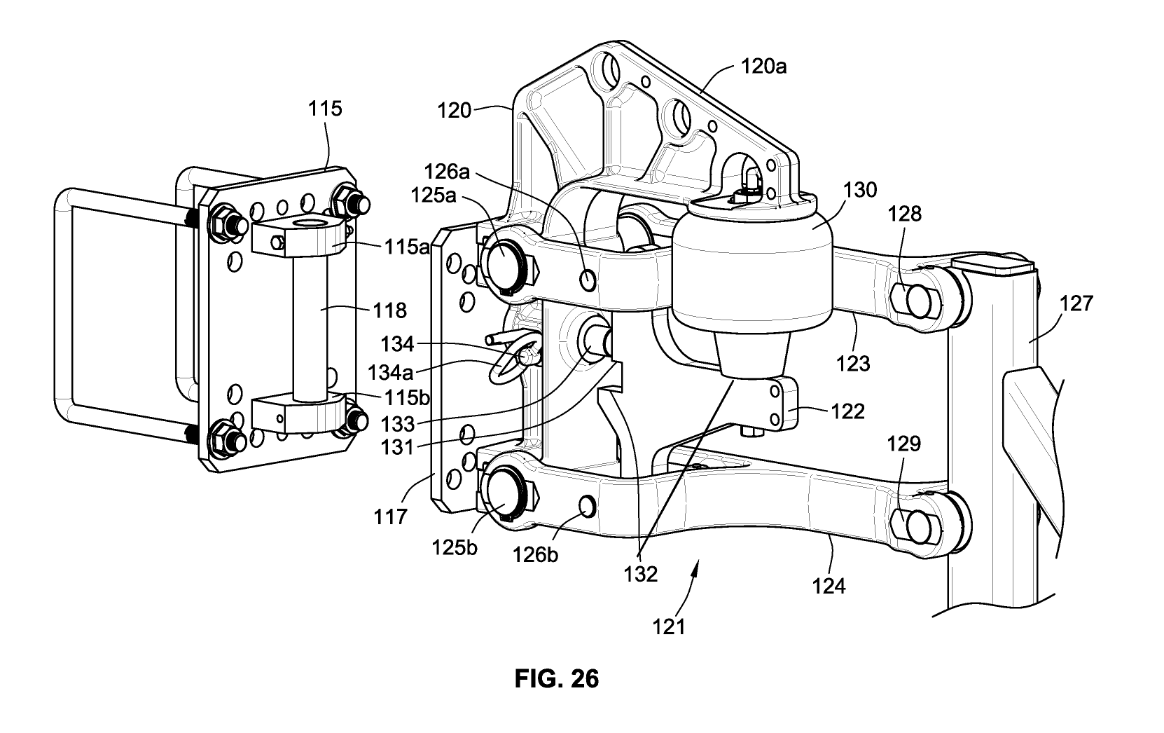

The rear side of the second attachment plate 117 is rigidly bolted to a post 120 that supports the leading ends of a parallel linkage 121, which in turn supports a cradle 122. by four bolts 117a-117d. The post 120 fits within a pair of forks formed by the leading ends of the two arms 123 and 124 of the linkage 121 (see FIG. 26), and the two arms 123 and 124 are pivotably connected to the post 120 by respective rods 125a and 125b that extend through the post 120. The two arms 123 and 124 are also pivotably coupled to the cradle 122 by a pair of pins 126a and 126b, and the trailing ends of the arms 123 and 124 are pivotably coupled to a tool-support arm 127 by a pair of pins 128 and 129.

The cradle 122 is attached to the lower end of an air spring 130, while the upper end of the air spring 130 is attached to a cantilevered portion 120a of the post 120. When the air pressure in the spring 130 is increased, the expansion of the air spring pushes downwardly on the linkage arms 123 and 124, which urges the arms 123 and 124 downwardly away from the cantilevered portion 120a of the post 120. When the air spring 130 is expanded by increasing the air pressure supplied to the spring, the downward force applied to the pivotably mounted arms 123 and 124 of the parallel linkage 121 is increased. This downward pressure can (1) pivot the trailing end of the linkage 121 downwardly around the axes of the pivotable connection between the linkage 121 and the post 120, and/or (2) increase the downward pressure on the tool-support arm 127 that is pivotably coupled to yokes formed by bifurcated trailing ends of the arms 123 and 124. Conversely, when the air spring 130 is contracted by reducing the air pressure supplied to the spring, the downward pressure on the arms 123 and 124 is reduced, which can (1) pivot the trailing end of the linkage 121 upwardly around the axes of the pivotable connection between the linkage 121 and the post 120 and/or (2) decrease the downward pressure on the tool-support arm 127.

The tool-support arm 127 carries the coulter wheel 112, the fertilizer dispenser 113 and the closing wheel 114. Thus, the downward pressure on both of the ground-engaging tools (the coulter wheel 12 and the closing wheel 114) may be remotely adjusted for different soil conditions by adjusting the air pressure supplied to the air spring 130.

As the row units 111 is advanced by a tractor, the coulter wheel 112 penetrates the soil to form a slit, and the dispensing device 113 injects liquid fertilizer into the slit. Then the slit is immediately closed by the closing wheel 114, which distributes loosened soil back into the slit. The closing wheel 114 also serves as a gauge wheel to control the depth of the slit and the elevation at which the liquid fertilizer is injected into the slit. Containers (not shown) on the row unit carry the fertilizer to be injected into the soil.

As can be seen in FIG. 23, the fertilizer dispenser 113 is positioned directly behind the trailing edge of the coulter wheel 114, at an elevation slightly below the surface of the soil so that the discharge nozzle is located within the slit opened by the coulter wheel. The discharge nozzle directs the liquid fertilizer downwardly into the slit (see FIG. 24) so that virtually all the fertilizer is still within the slit when the slit is closed by the closing wheel 114, which follows directly behind the dispenser 113. As can be seen in FIG. 23, the soil-engaging surface of the closing wheel 114 is concave so that the outer edges 114a and 114b penetrate deeper into the soil than the central portion 114c, thereby collapsing the side walls of the slit inwardly to close the slit and compact the soil at the top of the closed slit.

Referring to FIG. 26, the cradle 122 is stepped on its front surface to form one or more undercuts 130 and 131 and a bottom shoulder 132 for engaging a horizontal pin 133 movably mounted in the post 120. The pin 133 can be locked in different positions by a smaller transverse locking pin 134 attached to a handle 134a to facilitate manual insertion and withdrawal of the pin 134. The pin 133 has two transverse holes for receiving the smaller locking pin 134 to lock the pin 133 in different positions. In the position shown in FIG. 26, the pin 133 is in a retracted position where it overlaps the bottom shoulder 132 so as to limit the range of upward vertical travel of the cradle 122. When the cradle 122 is raised so that the lower undercut 130 is slightly above the top surface of the pin 133, the pin 133 can be moved to its most advanced position to lock the cradle at that elevation.

FIG. 27 illustrates an extension connector 200 that can be included in selected kits to permit the mounting of tools directly behind the toolbar drawn by the tractor. The connector 200 is coupled to the toolbar with the same C-clamps 1c described above, and then the tool-support elements 201 and 202 are coupled to the connector with C-clamps. In the illustrative example, the leading tool-support support element 201 carries a pair of toothed clearing wheels 203 and 204, and the second tool-support element 202 carries a stalk roller 205.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1-7. (canceled)

8. A kit of modular components for use in assembling different agricultural implements, the kit comprising:
a plurality of linkages including a first linkage L1 and a second linkage L2, the first linkage L1 having a different size than the second linkage L2, the first linkage L1 having a first end E1 and a second end E2 with a first pair of parallel arms mounted for vertical movement at the first end E1 of the first linkage L1, the second linkage L2 having a first end E1′ and a second end E2′ with a second pair of parallel arms mounted for vertical movement at the first end E1' of the second linkage L2;
a plurality of coupling elements including a first coupling element C1 and a second coupling element C2, the first coupling element C1 for mounting the first linkage L1 to a toolbar to be attached to a tractor, the second coupling element C2 for mounting the second linkage L2 to the toolbar;
a plurality of tool-support arms including a first tool-support arm A1 and a second tool-support arm A2, the first tool-support arm A1 being mountable, once at a time, to both the second end E2 of the first linkage L1 and the second end E2′ of the second linkage L2, the second tool-support arm A2 being mountable, once at a time, to both the second end E2 of the first linkage L1 and to the second end E2′ of the second linkage L2; and
a plurality of tools including a first tool T1 and a second tool T2, the first tool T1 being mountable on the first tool-support arm A1 and on the second tool-support arm A2, the second tool T2 being mountable on the first tool-support arm A1 and on the second tool-support arm A2.

9. The kit of modular components of claim 8, wherein at least the first linkage L1 has a controllable biasing element for applying a controllable downward force on the first pair of parallel arms for urging the first pair of parallel arms toward the soil.

10. The kit of modular components of claim 9, wherein the controllable biasing element is coupled between the first end E1 of the first linkage L1 and the first pair of parallel arms.

11. The kit of modular components of claim 9, wherein the controllable biasing element is an air spring.

12. The kit of modular components of claim 8, wherein the plurality of linkages, the plurality of coupling elements, the plurality of tool-support arms, and the plurality of tools can be used in different agricultural implements.

13. The kit of modular components of claim 8, further comprising additional elements for coupling the first linkage L1 and the second linkage L2 in tandem with each other.

14. The kit of modular components of claim 8, wherein at least one of the plurality of tool-support arms is adapted to carry both the first tool T1 and the second tool T2.

15. A kit of modular components for use in assembling different agricultural implements, the kit comprising:
a first modular system M1 including
a first linkage L1 having a first mounting end E1 and a second mounting end E2 with a first pair of parallel arms mounted for vertical movement near the first mounting end E1,
a first coupling element C1 for mounting the first mounting end E1 of the first linkage L1 to a tractor toolbar,
a first tool-support arm A1 being mountable to the second mounting end E2 of the first linkage L1, and
a first tool T1 being mountable to the first tool-support arm A1;
a second modular system M2 including
a second linkage L2 having a first mounting end E1′ and a second mounting end E2′ with a second pair of parallel arms mounted for vertical movement near the first mounting end E1′, the second linkage L2 having a different size than the first linkage L1,
a second coupling element C2 for mounting the first mounting end E1′ of the second linkage L2 to the tractor toolbar,
a second tool-support arm A2 being mountable to the second mounting end E2′ of the second linkage L2, and
a second tool T2 being mountable to the second tool-support arm A2;
a third modular system M3 having components from each of the first modular system M1 and the second modular system M2, the third modular system M3 including
the first linkage L1,
the first coupling element C1,
the second tool-support arm A2 being mountable to the second mounting end E2 of the first linkage L1, and
the second tool T2 being mountable to the second tool-support arm A2; and
a fourth modular system M4 having components from each of the first modular system M1 and the second modular system M2, the fourth modular system M4 including
the second linkage L2,
the second coupling element C2,
the first tool-support arm A1 being mountable to the second mounting end E2 of the second linkage L2, and
the first tool T1 being mountable to the first tool-support arm A1.

16. The kit of modular components of claim 15, further comprising a fifth modular system M5 having components from each of the first modular system M1 and the second modular system M2, the fifth modular system M5 including:
the first linkage L1,
the first coupling element C1,
the first tool-support arm A1,
the first tool T1, and
the second tool T2 being mountable to the first tool-support arm A1.

17. The kit of modular components of claim 15, further comprising a sixth modular system M6 having components from each of the first modular system M1 and the second modular system M2, the sixth modular system M6 including:
the first linkage L1,
the first coupling element C1,
the first tool-support arm A1,
the first tool T1,
the second tool-support arm A2 being mountable to the second mounting end E2 of the first linkage L1, and
the second tool T2 being mountable to the first tool-support arm A1.

18. The kit of modular components of claim 15, wherein at least the first linkage L1 has a controllable biasing element for applying a controllable downward force on the first pair of parallel arms for urging the first pair of parallel arms toward the soil, the controllable biasing element being coupled between the first end E1 of the first linkage L1 and the first pair of parallel arms.

19. The kit of modular components of claim 15, wherein the controllable biasing element is an air spring.

20. The kit of modular components of claim 15, wherein the modular systems M1-M4 can be used in different agricultural implements.

21. The kit of modular components of claim 15, further comprising additional elements for coupling the first linkage L1 and the second linkage L2 in tandem with each other.
